(19) United States
(12) Patent Application Publication
(10) Pub. No.: US 2025/0050673 A1
(43) Pub. Date: Feb. 13, 2025

(54) THERMAL TRANSFER RECORDING MEDIUM INCLUDING BASE MATERIAL LAYER, WELDING LAYER, FIRST THERMAL TRANSFER LAYER, AND SECOND THERMAL TRANSFER LAYER, PRINTING DEVICE, AND CASSETTE ACCOMMODATING THERMAL TRANSFER RECORDING MEDIUM

(71) Applicant: BROTHER KOGYO KABUSHIKI KAISHA, Nagoya (JP)

(72) Inventors: Masaya FUJITA, Toyokawa (JP); Satoru ITO, Nagoya (JP); Mina KATAOKA, Kyoto (JP); Haruki MATSUMOTO, Nagoya (JP); Yuki HOKARI, Nagoya (JP); Hiroaki NARUSE, Osaka (JP); Jiro HIRANO, Osaka (JP)

(21) Appl. No.: 18/927,059

(22) Filed: Oct. 25, 2024

Related U.S. Application Data
(63) Continuation of application No. PCT/JP2023/016247, filed on Apr. 25, 2023.

(30) Foreign Application Priority Data
Apr. 28, 2022 (JP) 2022-075255

(51) Int. Cl. B41M 5/44; B41J 15/04; B41M 5/382

(52) U.S. Cl. CPC B41M 5/44; B41J 15/044; B41M 5/38214; B41M 5/38228; B41M 2205/38; B41M 2205/42

(57) ABSTRACT

A thermal transfer recording medium includes: a base material layer; a welding layer; a first thermal transfer layer; and a second thermal transfer layer. The base material layer has a first surface and a second surface. The welding layer, the first thermal transfer layer, and the second thermal transfer layer are in direct contact with each other and are laminated in this order on the first surface of the base material layer. The welding layer has a solubility parameter higher than a solubility parameter of each of the base material layer and the first thermal transfer layer.

### REFERENCE TO RELATED APPLICATIONS

This is a by-pass continuation application of International Application No. PCT/JP2023/016247 filed on Apr. 25, 2023 claiming priority from Japanese Patent Application No. 2022-075255 filed on Apr. 28, 2022. The entire contents of the International Application and the priority application are incorporated herein by reference.

### BACKGROUND ART

For example, Japanese Patent Application Publication No. 2000-094843 and Japanese Patent Application Publication No. S62-227788 disclose thermal transfer recording media capable of recording characters in different colors (e.g., two colors black and red). A thermal transfer recording medium of this type is set in a specialized printing device. By adjusting the amount of applied energy directed to a thermal head in the printing device, the device can transfer characters of different colors onto a printing medium.

### SUMMARY

It is an object of the present disclosure to provide a thermal transfer recording medium capable of recording characters in at least two colors with good clarity.

In order to attain the above and other objects, according to one aspect, the present disclosure provides a thermal transfer recording medium. The thermal transfer recording medium includes: a base material layer; a welding layer; a first thermal transfer layer; and a second thermal transfer layer. The base material layer has a first surface and a second surface. The welding layer, the first thermal transfer layer, and the second thermal transfer layer are in direct contact with each other and are laminated in this order on the first surface of the base material layer. The welding layer has a solubility parameter higher than a solubility parameter of each of the base material layer and the first thermal transfer layer.

The thermal transfer recording medium according to one embodiment of the present disclosure includes a welding layer having a solubility parameter (SP value) higher than a solubility parameter (SP value) of each of a base material layer and a first thermal transfer layer. Therefore, the thermal transfer recording medium can record characters in at least two colors with good clarity.

According to another aspect, the present disclosure also provides a thermal transfer recording medium. The thermal transfer recording medium includes: a base material layer; a wielding layer; a first thermal transfer layer; and a second thermal transfer layer. The base material layer has a first surface and a second surface. The welding layer, the first thermal transfer layer, and the second thermal transfer layer are in direct contact with each other and are laminated in this order on the first surface of the base material layer. When the thermal transfer recording medium is heated at a low temperature higher than or equal to a first temperature and lower than or equal to a second temperature, bonding strength between the welding layer and the first thermal transfer layer is greater than a bonding strength between the first thermal transfer layer and the second thermal transfer layer. When the thermal transfer recording medium is heated at a high temperature higher than the second temperature, the bonding strength between the first thermal transfer layer and the second thermal transfer layer is greater than a bonding strength between the base material layer and the first thermal transfer layer.

According to still another aspect, the present disclosure further provides a thermal transfer recording medium. The thermal transfer recording medium includes: a base material: a welding layer; a first ink layer; and a second ink layer. The welding layer contains a welding material. The first ink layer contains first ink. The second ink layer contains second ink. The base material layer, the welding layer, the first thermal transfer layer, and the second thermal transfer layer are laminated in this order. At least a portion of the first ink layer and the second ink layer is configured to be thermally transferred onto a printing medium. When external forces are applied to both the base material layer and the second ink layer in directions away from each other in a first state, a breakage occurs between the first ink layer and the second ink layer or within the second ink layer. The first state is a state in which the thermal transfer recording medium has been heated to a temperature higher than or equal to a first temperature and lower than or equal to a second temperature and subsequently cooled to a temperature lower than or equal to a third temperature. When the external forces are applied in a second state, a breakage occurs between the first ink layer and the base material layer or within the first ink layer. The second state is a state in which the thermal transfer recording medium has been heated to a temperature higher than the second temperature and subsequently cooled to a temperature lower than or equal to the third temperature.

According to still another aspect, the present disclosure also provides a printing device. The printing device is configured to perform: a heating process; a cooling process; and a transfer process. The heating process heats a thermal transfer recording medium in a state where the thermal transfer recording medium is in contact with a printing medium. The thermal transfer recording medium includes: a base material layer; a first ink layer; and a second ink layer. The first ink layer contains first ink. The second ink layer contains second ink. The base material layer, the first ink layer, and the second ink layer are laminated in this order. The cooling process cools the thermal transfer recording medium heated in the heating process. The transfer process transfers at least part of the first ink and the second ink onto the printing medium by applying external forces to both the base material layer and the second ink layer of the thermal transfer recording medium cooled in the cooling process in directions away from each other. In the heating process and the cooling process, the printing device heats a first portion of the thermal transfer recording medium to a temperature higher than or equal to a first temperature and lower than or equal to a second temperature and subsequently cools the first portion to a temperature lower than or equal to a third temperature to place the first portion in a first state, and the printing device heats a second portion of the thermal transfer recording medium to a temperature higher than the second temperature and subsequently cools the second portion to a temperature lower than or equal to the third temperature to place the second portion in a second state. In the transfer process, the printing device applies the external forces to break the thermal transfer recording medium between the first ink layer and the second ink layer or within the second ink layer at the first portion of the thermal transfer recording medium and transfer second ink onto the printing medium. In the transfer process, the printing device applies the external forces to break the thermal transfer recording medium between the first ink layer and the base material layer or within the first ink layer at the second portion of the thermal transfer recording medium and transfer the first ink and the second ink onto the printing medium.

According to still another aspect, the present disclosure further provides a cassette. The cassette accommodates therein: a thermal transfer recording medium; and a printing medium. The thermal transfer recording medium includes: a base material layer; a welding layer; a first thermal transfer layer; and a second thermal transfer layer. The base material layer has a first surface and a second surface. A portion of the thermal transfer recording medium is to be thermally transferred onto the printing medium. In the thermal transfer recording medium, the welding layer, the first thermal transfer layer, and the second thermal transfer layer are in direct contact with each other and are laminated in this order on the first surface of the base material. The welding layer has a solubility parameter higher than a solubility parameter of each of the base material layer and the first thermal transfer layer.

### BRIEF DESCRIPTION OF DRAWINGS

FIG. 1 is a diagram schematically illustrating the structure of a printing device.

FIG. 2 is a block diagram illustrating the electrical configuration of the printing device.

FIG. 3 is a schematic diagram illustrating a heating process and a cooling process performed in the printing device.

FIGS. 4A and 4B are schematic diagrams illustrating the cooling process and a transfer process performed in the printing device.

FIGS. 5A and 5B are diagrams illustrating one example of a printing pattern printed on the printing device.

FIG. 6 is a schematic cross-sectional view illustrating the layered configuration of an ink ribbon.

FIG. 7 is a diagram illustrating the relationship between elapsed time and the attained temperature of a thermal transfer recording medium during the heating process and the cooling process.

FIG. 8 is a diagram illustrating the relationship between elapsed time and interlayer bonding strengths within the thermal transfer recording medium during the heating process and cooling process.

FIG. 9 is a diagram illustrating the relationship between elapsed time and interlayer bonding strengths within the thermal transfer recording medium during the heating process and cooling process.

FIG. 10 is a diagram illustrating a peeling state of the thermal transfer recording medium.

FIG. 11 is a diagram illustrating a peeling state of the thermal transfer recording medium.

FIG. 12 is a diagram illustrating a peeling state of the thermal transfer recording medium.

FIG. 13 is a diagram illustrating a peeling state of the thermal transfer recording medium.

FIG. 14 is a diagram illustrating a peeling state of the thermal transfer recording medium.

FIG. 15 is a diagram illustrating a peeling state of the thermal transfer recording medium.

FIG. 16 is a diagram illustrating a peeling state of the thermal transfer recording medium.

FIG. 17 is a diagram illustrating a peeling state of the thermal transfer recording medium.

FIG. 18 is a diagram provided for comparing solubility parameters (SP values) of comment materials in the thermal transfer recording medium.

FIG. 19 is a diagram illustrating the magnitude relationships among types of materials forming parts of the thermal transfer recording medium and solubility parameters.

FIG. 20 is a table listing components used in the preparation of a coating material for a first thermal transfer layer.

FIG. 21 is a table in which material names, SP values, and softening points for coating materials for welding layers are summarized.

FIG. 22 is a table in which material names, MFRs, and styrene contents of coating materials for intermediate layers are summarized.

FIG. 23 is a table listing components used in the preparation of a coating material for a second thermal transfer layer.

FIG. 24 is a table listing the results of experimental examples regarding consecutive recordability and breaking positions.

FIG. 25 is a table listing the results of experimental examples regarding consecutive recordability and breaking positions.

FIG. 26 is a table listing the results of experimental examples regarding consecutive recordability and breaking positions.

FIG. 27 is a table listing the results of experimental examples regarding consecutive recordability and breaking positions.

FIG. 28 is a table listing the results of experimental examples regarding consecutive recordability and breaking positions.

### DESCRIPTION

Next, an embodiment of the present disclosure will be described in detail while referring to the accompanying drawings.

### [Overall Configuration of a Printing Device 1]

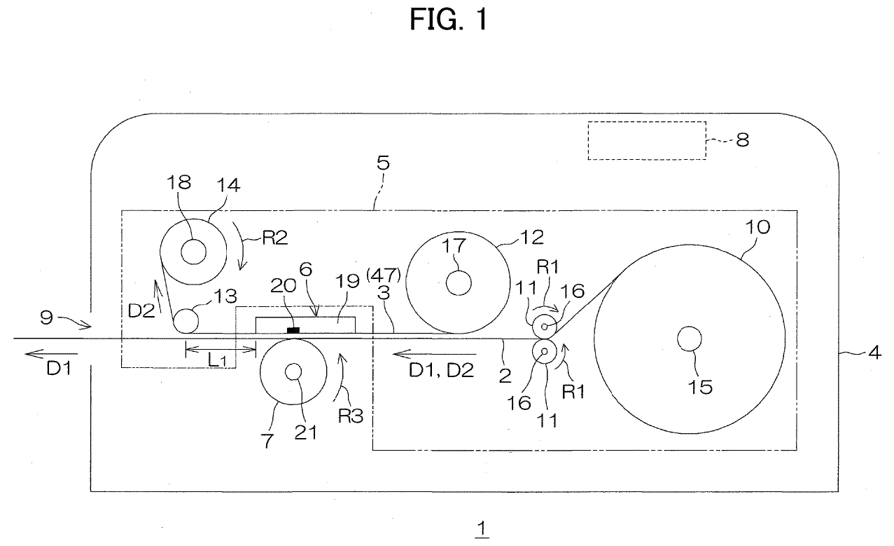

FIG. 1 is a diagram schematically illustrating the structure of a printing device 1 according to one embodiment of the present disclosure.

Referring to FIG. 1, the printing device 1 is a thermal transfer printer that thermally transfers ink from an ink ribbon 3 onto a printing tape 2, which is one example of the printing medium, as characters. The printing tape 2 may include a strip-shaped film tape including a base material to which ink is directly transferred and a paper label tape having numerous paper labels arranged along a strip-shaped base film, for example.

Characters recorded on the printing tape 2 may include standard characters; barcodes, QR codes (registered trademark), and other symbols; numbers; figures; and patterns, for example. The printing device 1 according to this embodiment can record characters in different colors (e.g., two colors black and red) on the printing tape 2. “QR code” is a registered trademark of DENSO WAVE CORPORATED.

The printing device 1 primarily includes a housing 4 and, accommodated inside the housing 4, a tape cassette 5, a thermal head 6, a platen roller 7, and a control board 8.

The housing 4 may be a box-shaped member configured of a plastic case, for example. An outlet 9 is formed in an outer wall of the housing 4 for removing printing tape 2 that has been printed. A cutter (not illustrated) may be provided near the outlet 9. By using the cutter to cut the printing tape 2, labels can be separated and removed in sizes conforming to the amounts of printing tape 2 used.

The tape cassette 5 may be removably mounted in the housing 4. The tape cassette 5 may accommodate, in order from the upstream side to the downstream side of a conveying direction D1 of the printing tape 2 (the direction from right to left in FIG. 1), a printing tape roll 10 (also known as a label tape roll), supply rollers 11, an ink ribbon roll 12, an ink ribbon peeling member 13, and an ink ribbon take-up roll 14. In this embodiment, the printing tape roll 10 and ink ribbon roll 12 are of a type used while accommodated in the tape cassette 5, but the printing tape roll 10 and ink ribbon roll 12 may be of a type used while directly mounted in the printing device 1, for example.

The printing tape roll 10 is prepared by winding the printing tape 2 into a cylindrical shape and is rotatably held by a shaft 15 in the tape cassette 5, for example. Tape drive shafts 16 provided in the housing 4 are inserted into respective supply rollers 11. Rotational forces R1 generated by the drives of the tape drive shafts 16 are transmitted to the corresponding supply rollers 11 to rotate the supply rollers 11.

The ink ribbon roll 12 is prepared by winding the ink ribbon 3 into a cylindrical shape and is rotatably held by a shaft 17 in the tape cassette 5, for example. A ribbon drive shaft 18 provided in the housing 4 is inserted into the ink ribbon take-up roll 14. A rotational force R2 generated by the drive of the ribbon drive shaft 18 is transmitted to the ink ribbon take-up roll 14 to rotate the ink ribbon take-up roll 14.

The ink ribbon peeling member 13 may be a guide member that changes a conveying direction D2 of the ink ribbon 3. The ink ribbon peeling member 13 is shaped for contacting the ink ribbon 3 being conveyed and may have a roller shape or a blade shape, for example. The ink ribbon 3 is conveyed toward the outlet 9 together with the printing tape 2 while portions of the ink ribbon 3 are bonded to the printing tape 2 through thermocompression by the thermal head 6. The ink ribbon peeling member 13 contacts the ink ribbon 3 being conveyed and changes the conveying direction D2 of the ink ribbon 3 at a steep angle to the conveying direction D1 of the printing tape 2. As a result, the printing tape 2 and ink ribbon 3 are pulled apart, peeling the ink ribbon 3 off the printing tape 2.

The thermal head 6 is arranged between the ink ribbon peeling member 13 and the printing tape roll 10 and ink ribbon roll 12 in the conveying direction D1 of the printing tape 2. The thermal head 6 includes a substrate 19, and a heating element 20 (e.g., heating resistor or the like) formed on the substrate 19. The Joule heat generated by electricity supplied to the heating element 20 is used to thermally transfer ink from the ink ribbon 3.

A platen drive shaft 21 provided in the housing 4 is inserted into the platen roller 7, for example. A rotational force R3 generated by the drive of the platen drive shaft 21 is transmitted to the platen roller 7 to rotate the platen roller 7. The control board 8 is an electronic device that performs electrical control of the printing device 1, and is provided inside the housing 4.

### [Electrical Configuration of the Printing Device 1]

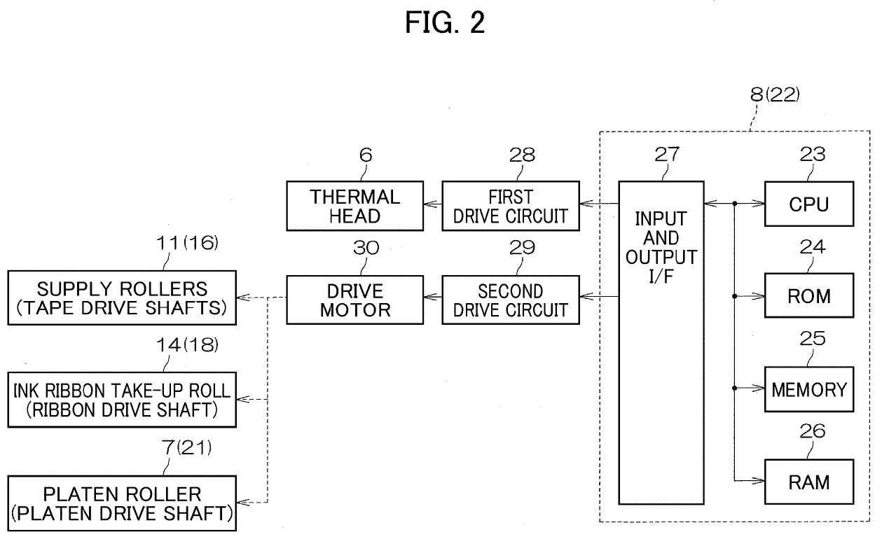

FIG. 2 is a block diagram illustrating the electrical configuration of the printing device 1.

Referring to FIG. 2, the control board 8 of the printing device 1 is provided with a control circuit 22. The control circuit 22 may include a CPU 23, a ROM 24, a memory 25, a RAM 26, and an input and output interface (I/F) 27. These components are electrically connected to each other via a data bus (not illustrated), for example.

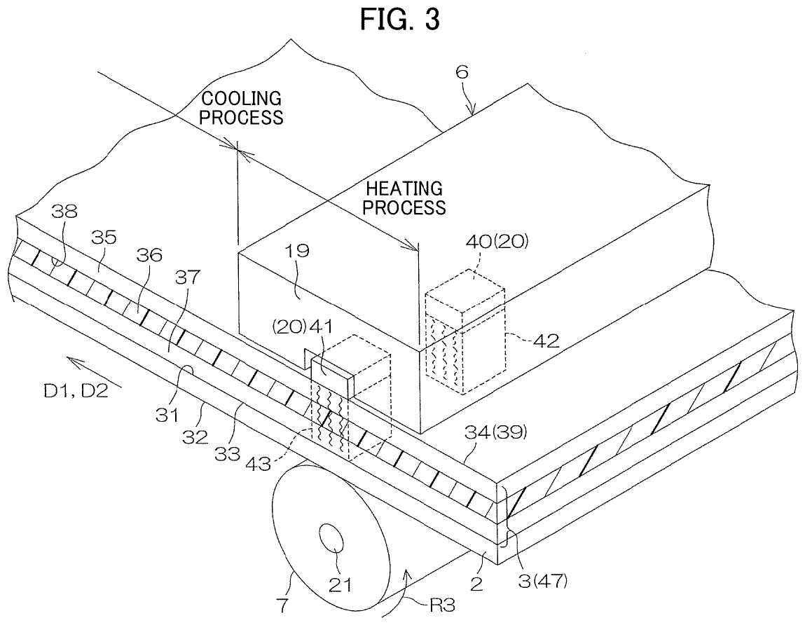

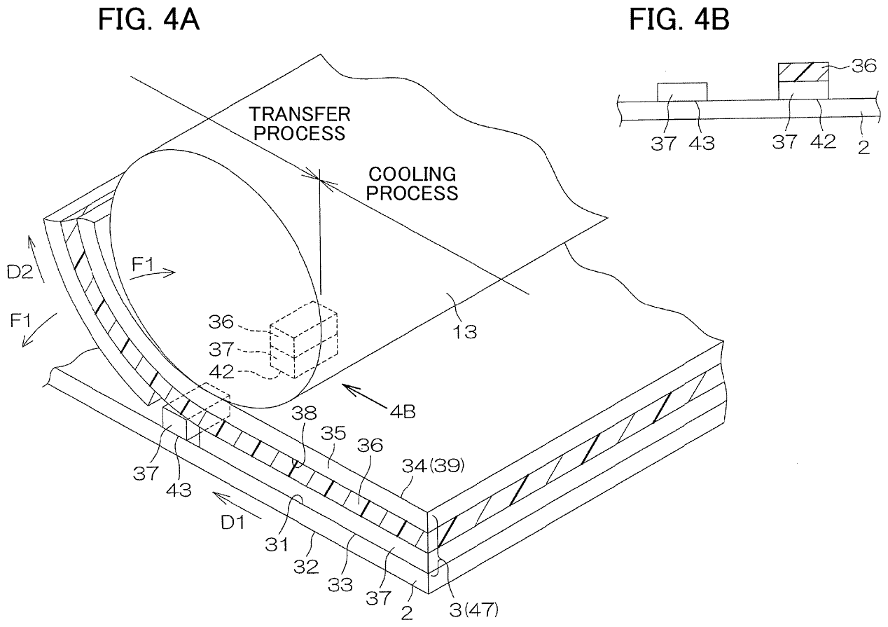

The ROM 24 stores various programs for driving the printing device 1 (e.g., control programs for performing the processes illustrated in FIGS. 3, 4A, and 4B). The CPU 23 performs overall control of the printing device 1 by performing signal processing according to a program stored in the ROM 24 while utilizing the temporary storage function of the RAM 26. The memory 25 may be configured of a portion of the storage area in the ROM 24, for example. The memory 25 may store in advance a table for displaying the remaining amount (or consumed amount) of the ink ribbon 3 on a display unit (not illustrated) provided on the housing 4.

The input and output I/F 27 is electrically connected to a first drive circuit 28, and a second drive circuit 29. The first drive circuit 28 controls energization of the heating element 20 in the thermal head 6. The second drive circuit 29 performs drive control for outputting drive pulses to a drive motor 30. The drive motor 30 drives the supply rollers 11, the ink ribbon take-up roll 14, and the platen roller 7 to rotate.

### [Steps in Printing Processes Performed on the Printing Device 1]

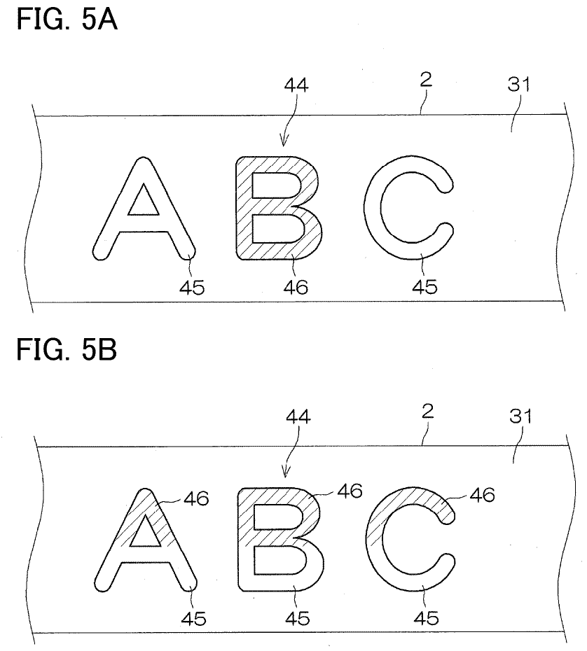

FIG. 3 is a schematic diagram illustrating a heating process and a cooling process performed in the printing device 1. FIGS. 4 and 4B are schematic diagrams illustrating the cooling process and a transfer process performed in the printing device 1. FIG. 4B is a partial enlarged view of a transfer pattern when viewed in the direction of arrow 4B in FIG. 4A. FIGS. 5A and 5B are diagrams illustrating one example of a printing pattern 44 printed on the printing device 1. A specific example of a printing process performed on the printing device 1 will be described with reference to FIGS. 1, 3, 4A, 4B, 5A, and 5B.

To print characters on the printing tape 2, the printing tape 2 is drawn off the printing tape roll 10 by the rotational drive of the supply rollers 11, and the ink ribbon 3 is drawn off the ink ribbon roll 12 by the rotational drive of the ink ribbon take-up roll 14.

As a result, the printing tape 2 and ink ribbon 3 are conveyed toward the downstream side in an overlapped state of each other, as illustrated in FIGS. 1 and 3. The surface of the printing tape 2 on the ink ribbon 3 side is a printing surface 31 (front surface), while the surface on the opposite side is a back surface 32. The surface of the ink ribbon 3 on the printing tape 2 side is a bonding surface 33 (front surface), while the surface on the opposite side is a back surface 34.

Referring to FIG. 3, the ink ribbon 3 includes a base material layer 35, a first ink layer 36 as one example of the first thermal transfer layer, and a second ink layer 37 as one example of the second thermal transfer layer. The first ink layer 36 and second ink layer 37 are laminated in this order to a front surface 38 of the base material layer 35 as one example of the first surface of the base material layer 35. The surface of the base material layer 35 on the opposite side of the front surface 38 is a back surface 39 (the back surface 34 of the ink ribbon 3). The first ink layer 36 and second ink layer 37 contain colorants that are of mutually different colors. For example, the first ink layer 36 may contain a black colorant as one example of the first ink, and the second ink layer 37 may contain a red colorant as one example of the second ink.

The ink ribbon 3 is conveyed toward the thermal head 6 with the second ink layer 37 in contact with the printing tape 2. The heating process is executed by the thermal head 6, as illustrated in FIG. 3. Specifically, the thermal head 6 presses the heating element 20, which has been heated through energization, against the ink ribbon 3. This heat is transferred to the first ink layer 36 and second ink layer 37 through the base material layer 35. Interposed between the thermal head 6 and platen roller 7, the laminate of the ink ribbon 3 and printing tape 2 is conveyed downstream while being heated by the thermal head 6.

The heating element 20 may be controlled to be the same temperature throughout or to have different temperatures in parts. For example, a first portion 40 of the heating element 20 may be controlled at a first heating temperature, and a second portion 41 of the heating element 20 may be controlled at a second heating temperature that differs from the first heating temperature, as illustrated in FIG. 3. As a result, the ink ribbon 3 may include a first portion 42 heated by the first heating temperature, and a second portion 43 heated by the second heating temperature. At least some or all of the first ink layer 36 and second ink layer 37 in the first portion 42 and second portion 43 of the ink ribbon 3 are melted or softened and adhere to the printing tape 2.

Referring to FIGS. 3, 4A, and 4B, the cooling process is executed in the section between the thermal head 6 and the ink ribbon peeling member 13. Specifically, the ink ribbon 3 that has been bonded to the printing tape 2 through thermocompression in the heating process is cooled naturally in the section from the thermal head 6 to the ink ribbon peeling member 13 so that the temperature of the ink ribbon 3 decreases toward the ambient operating temperature in the printing device 1.

Thereafter, as illustrated in FIGS. 4A and 4B, the ink ribbon peeling member 13 selectively changes only the conveying direction D2 of the ink ribbon 3, applying an external force F1 to each of the base material layer 35 and second ink layer 37 in directions away from each other. As a result, the printing tape 2 and ink ribbon 3 are pulled apart and the ink ribbon 3 is wound onto the ink ribbon take-up roll 14. At this time, a transfer process occurs with the first portion 42 and second portion 43 of the ink ribbon 3, which have been heated by the thermal head 6, selectively remaining on the printing tape 2. In the first portion 42, for example, a laminate including the first ink layer 36 and second ink layer 37 may peel off the base material layer 35 and be transferred to the printing tape 2. In the second portion 43, on the other hand, the first ink layer 36 and second ink layer 37 may peel apart, with the second ink layer 37 being selectively transferred onto the printing tape 2.

As a result, a printing pattern 44 having different colors (the two colors black and red in this example) is formed on the printing tape 2. As illustrated in the example of FIG. 5A, individual characters in the printing pattern 44 may have different colors. When the printing tape 2 in FIG. 5A is viewed from the printing surface 31 side, a red pattern 45 formed from the second ink layer 37 may be visible on the outermost surface of each of the alphabetic characters “A” and “C”, and a black pattern 46 formed from the first ink layer 36 may be visible on the outermost surface of the alphabetic character “B”. As illustrated in the example of FIG. 5B, on the other hand, in the printing pattern 44, both a red pattern 45 and a black pattern 46 may be visible in portions of each character.

After the ink ribbon 3 has been transferred, the printing tape 2 on which the characters are recorded is removed from the printing device 1 through the outlet 9.

### [One Example of Problems in Two-Color Printing]

In thermal transfer printers (such as the printing device 1), the ink ribbon 3 is heated by the thermal head 6 according to a pattern in recording information and is subsequently peeled off the printing tape 2. As a result, the ink layers 36 and 37 are selectively melted or softened according to the heating pattern, peeled off the base material layer 35, and transferred onto the printing surface 31 of the printing tape 2 to record characters on the printing surface 31. Such two-color thermal transfer printing was also disclosed in PTL 1 and PTL 2 described above but has the following issues.

For example, PTL 1 discloses a thermal transfer sheet for two-color recording that includes a base material and a plurality of thermal transfer ink layers with mutually different hues (e.g., a first thermal transfer ink layer and a second thermal transfer ink layer) laminated on the base material. Both thermal transfer ink layers are formed of thermoplastic resin, wax, or the like.

In Japanese Patent Application Publication No. 2000-094843, when a thermal transfer is performed at a relatively low temperature by applying a relatively low energy to the thermal head, for example, the first thermal transfer ink layer softens to reduce its adhesion strength to the base material, and the second thermal transfer layer softens to create adhesion strength to the surface of the transfer receiver.

However, both thermal transfer ink layers maintain their adhesion strength to each other by softening together and, as a result, the entire thermal transfer ink layer, i.e., the first and second thermal transfer ink layers, are thermally transferred together onto the surface of the transfer receiver. Therefore, the characters recorded on the surface of the transfer receiver will appear in the hue of the first thermal transfer ink layer occupying the outermost layer after the transfer, e.g., black.

On the other hand, when a thermal transfer is performed at a higher temperature by applying a relatively high energy to the thermal head, the first thermal transfer ink layer is further softened, which conversely increases its adhesion strength to the base material, and the second thermal transfer ink layer softens to create adhesion strength to the surface of the transfer receiver. In this thermal transfer, a reverse transfer occurs in which the first thermal transfer ink layer remains on the base material side. Consequently, only the second thermal transfer ink layer is selectively transferred onto the surface of the transfer receiver. Therefore, the characters recorded on the surface of the transfer receiver appear in the hue of the second thermal ink layer, e.g., red.

However, between the range of transfer temperatures (approximately equivalent to the amount of energy applied to the thermal head; the same applies hereafter) when both thermal transfer ink layers are thermally transferred together (hereinafter sometimes abbreviated to the “low-temperature transfer range”) and the range of transfer temperatures in which only the second thermal transfer ink layer is thermally transferred (hereinafter sometimes abbreviated to the “high-temperature transfer range”), there may exist a range of transfer temperatures in which a portion of the first thermal transfer ink layer is transferred together with the second thermal transfer ink layer, making the hues of the characters appear cloudy (hereinafter sometimes abbreviated to the “cloudy transfer range”).

Moreover, a thermal transfer sheet having both thermal transfer ink layers directly laminated together tends to have a wide cloudy transfer range and narrow low-temperature range and high-temperature transfer range. Furthermore, heat tends to accumulate in the thermal head, causing the temperature of the thermal head to rise gradually during continuous thermal transfer printing.

Therefore, it is particularly difficult to maintain the temperature of the thermal head within the low-temperature transfer range, and the hues of characters tend to appear cloudy during low-temperature transfers.

The thermal transfer sheet of Japanese Patent Application Publication No. 2000-094843 may further include a release layer formed between the first thermal transfer ink layer and second thermal transfer ink layer. The release layer is made of a colorless transparent wax or the like having low melt viscosity and high fluidity. The release layer melts or softens during a thermal transfer to facilitate separation of the both thermal transfer ink layers. Here, the high-temperature transfer range can be expanded toward the low temperature side to reduce the cloudy transfer range. However, this tends also to contract the low-temperature transfer range in which both thermal transfer ink layers can be transferred together while suppressing the peeling of the release layer. Wax can also easily affect its surroundings due to its low melt viscosity. Excessive peeling may occur, particularly when recording fine images such as barcodes, resulting in reduced clarity of the recording.

Japanese Patent Application Publication No. S62-227788 discloses an ink ribbon that includes a base, and a first ink layer and a second ink layer directly laminated on the base. In Japanese Patent Application Publication No. S62-227788, the ink ribbon is first heated in the low-temperature transfer range, and both ink layers are thermally transferred together onto the surface of the recording paper. If only the second ink layer is to remain thereon, consideration was given for subsequently reheating the ink ribbon while peeling the ink ribbon in order to transfer the first ink layer back onto the base side. However, this type of thermal transfer printing described in Japanese Patent Application Publication No. S62-227788 requires a printer provided with a special thermal head that can perform reheating after an initial thermal transfer, making the method less versatile.

When considering the thermal transfer methods of Japanese Patent Application Publication No. 2000-094843 and Japanese Patent Application Publication No. S62-227788, the inventors of the present application identified multiple problems. At least one of these problems (the first problem) is to provide a thermal transfer recording medium (an ink ribbon) capable of simultaneously recording characters in at least two colors with good clarity.

Another problem (the second problem) is to provide a thermal transfer recording medium (an ink ribbon) that can be clearly separated into two colors with little cloudiness of hues, even during continuous thermal transfer recording, while using a general-purpose thermal transfer printer that supports two-color recording.

Another of the aforementioned multiple problems (the third problem) is to provide a thermal transfer recording medium (an ink ribbon) that can be clearly separated into two colors with little cloudiness of hues, even during continuous thermal transfer recording, and moreover that can record characters with excellent clarity and no excessive peeling, when using a general-purpose thermal transfer printer that supports two-color recording.

### [Introduction of a Welding Layer 70]

In order to overcome the multiple problems described above, the inventors of this application studied and introduced a welding layer into a thermal transfer recording medium (an ink ribbon), which will be described below in detail.

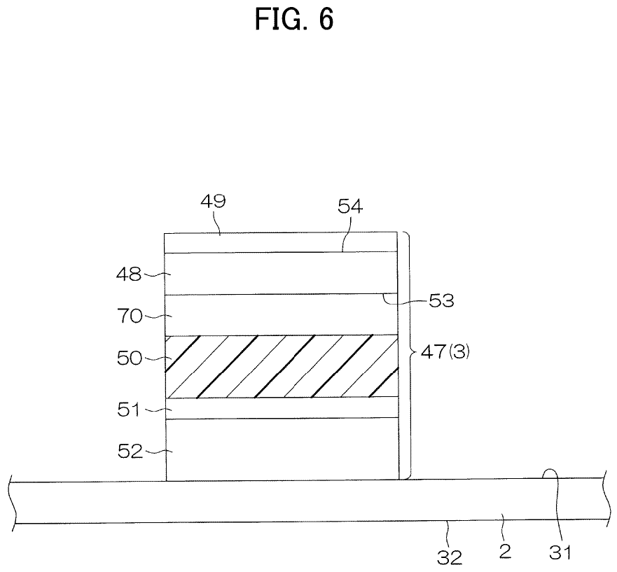

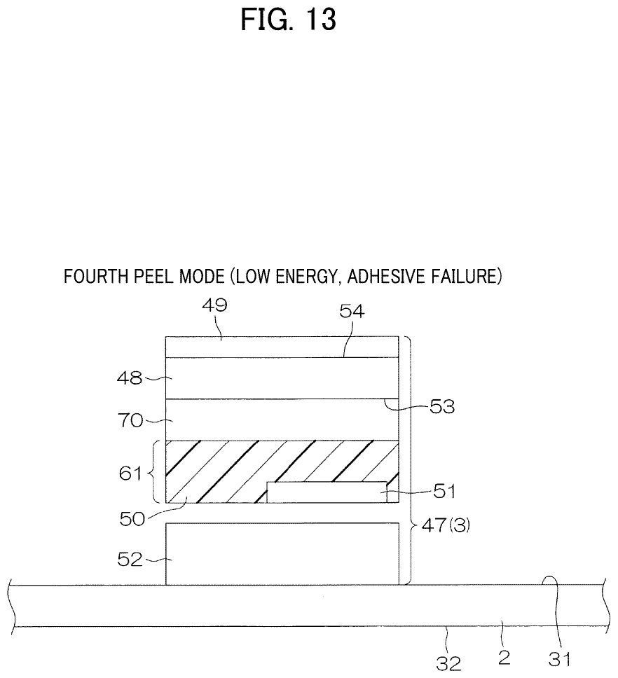

FIG. 6 is a schematic cross-sectional view illustrating the layered configuration of the thermal transfer recording medium 47 according to one embodiment of the present disclosure. The thermal transfer recording medium 47 depicted in FIG. 13 is bonded to the printing tape 2 as one example of the printing medium.

The thermal transfer recording medium 47 may be used as the ink ribbon 3 in the printing device 1 and printing process illustrated in FIGS. 1 through 4A and 4B. The thermal transfer recording medium 47 includes a base material layer 48, a backing layer 49, a welding layer 70, a first thermal transfer layer 50, an intermediate layer 51, and a second thermal transfer layer 52. The welding layer 70, first thermal transfer layer 50, intermediate layer 51, and second thermal transfer layer 52 are laminated to a front surface 53 of the base material layer 48 in this order. The surface of the base material layer 48 on the opposite side of the front surface 53 may be a back surface 54. The backing layer 49 is laminated on the back surface 54 of the base material layer 48. The first thermal transfer layer 50 and second thermal transfer layer 52 may be referred to as the first ink layer and second ink layer, respectively.

A feature of the thermal transfer recording medium 47 in the present disclosure is that the thermal transfer recording medium 47 includes the base material layer 48; and the welding layer 70, first thermal transfer layer 50, intermediate layer 51, and second thermal transfer layer 52, which are in direct contact with each other and are laminated in this order on the front surface 53 of the base material layer 48. The intermediate layer 51 includes a thermoplastic elastomer as a binder. However, the intermediate layer 51 may be omitted.

Provided below is a detailed description of the specific composition, properties, and the like of the base material layer 48, backing layer 49, welding layer 70, first thermal transfer layer 50, intermediate layer 51, and second thermal transfer layer 52 included in the thermal transfer recording medium 47.

### (1) Base Material Layer 48

Some examples of materials used for the base material layer 48 are films of polysulfone, polystyrene, polyamide, polyimide, polycarbonate, polypropylene, polyester, triacetate, and other resins; thin paper such as condenser paper or glassine paper; and cellophane. Of these, polyester films, such as polyethylene terephthalate (PET) and polyethylene naphthalate, are preferred in terms of their mechanical strength, dimensional stability, heat treatment resistance, cost, and the like. The thickness of the base material layer 48 can be set arbitrarily according to the specifications of the thermal transfer printer, for example. For example, the base material layer 48 may have a thickness greater than or equal to 1 μm, and preferably greater than or equal to 2 μm.

For example, the base material layer 48 may have a thickness less than or equal to 10 μm, and preferably less than or equal to 8 μm. For example, the base material layer 48 may have a thickness greater than or equal to 1 μm and less than or equal to 10 μm, and preferably greater than or equal to 2 μm and less than or equal to 8 μm.

### (2) Backing Layer 49

The backing layer 49 improves the heat resistance, sliding property, abrasion resistance, and the like of the back surface 54 of the base material layer 48 that contacts the thermal head 6. Some examples of materials used as the backing layer 49 are silicone resin, fluorine resin, silicone-fluorine copolymer resin, nitrocellulose resin, silicone-modified urethane resin, and silicone-modified acrylic resin. The backing layer 49 may also contain lubricants as needed.

For example, the backing layer 49 can be formed by applying a coating material having one of the above resins or the like dissolved or dispersed in any solvent to the back surface 54 of the base material layer 48, and then drying the coating material. The thickness of the backing layer 49 can be set arbitrarily according to the specifications of the thermal transfer printer or the like, for example. The thickness of the backing layer 49 can be adjusted by the coating amount of the backing layer 49.

For example, the coating amount of the backing layer 49 when expressed as the mass of solids per unit area is greater than or equal to 0.05 g/m², and preferably greater than or equal to 0.1 g/m². For example, the coating amount of the backing layer 49 when expressed as the mass of solids per unit area is less than or equal to 0.5 g/m², and preferably less than or equal to 0.4 g/m². For example, the coating amount of the backing layer 49 when expressed as the mass of solids per unit area is greater than or equal to 0.05 g/m² and less than or equal to 0.5 g/m², and preferably greater than or equal to 0.1 g/m² and less than or equal to 0.4 g/m². The specific thickness of the backing layer 49 is greater than or equal to 0.05 μm, for example, and preferably greater than or equal to 0.1 μm. The thickness of the backing layer 49 is less than or equal to 0.5 μm, for example, and preferably less than or equal to 0.4 μm. The thickness of the backing layer 49 may be greater than or equal to 0.05 μm and less than or equal to 0.5 μm, for example, and preferably greater than or equal to 0.1 μm and less than or equal to 0.4 μm.

### (3) Welding Layer 70

The welding layer 70 includes at least one type of resin selected from the group consisting of polyamide-based resins, polyester-based resins, epoxy-based resins, phenol-based resins, and polyvinyl alcohol-based resins, for example. A welding layer 70 formed of a polyamide-based resin is preferable with consideration for improving affinity and adhesion strength to the base material layer 48 and first thermal transfer layer 50 during low-temperature heating.

Examples of polyamide-based resins include polyamides obtained through the polycondensation of lactams containing a three or more membered ring, polymerizable aminocarboxylic acids, dibasic acids and diamines or their salts, or mixtures thereof. These polyamide-based resins can be used alone or in a combination of two or more types.

Some specific examples of commercially available polyamide-based resins include polyamide-based resins from the TOHMIDE (registered trademark) series manufactured by T&K TOKA Co., Ltd: 1310 (softening point: 120±5° C., melt viscosity: 1500-4500 mPa·s/200° C.); 1315 (softening point: 130±5° C., melt viscosity: 7000-18000 mPa·s/200° C.); 1320 (softening point: 100±5° C., melt viscosity: 11000-20000 mPa·s/200° C.); 1340 (softening point: 140±5° C., melt viscosity: 8000-16000 mPa·s/200° C.); TXC-243A (softening point: 105±5° C., melt viscosity: 5000-10000 mPa·s/200° C.); TXC-245A (softening point: 90±5° C., melt viscosity: 1000-2000 mPa·s/200° C.); and the like. “TOHMIDE” is a Japanese registered trademark of T&K TOKA Co., Ltd.

Note that when comparing temperatures related to thermal deformation of a plurality of substances in the present application, the softening point is used as the comparison temperature for cases in which the substances have a softening point, such as polyamide-based resins. In the case of substances having a melting point (e.g., waxes and the like described later), the melting point is used as the comparison temperature. In the case of substances that do not have either a melting point or a softening point but have a glass transition temperature (e.g., polyester-based resins and the like described later), the glass transition temperature is used as the comparison temperature.

Some specific examples of commercially available polyester-based resins include polyester-based resins from the elitel (registered trademark) series manufactured by Unitika Ltd.: UE-3320; UE-9820; UE-3350; UE-3380; and the like, and polyester-based resins from the VYLON (registered trademark) series manufactured by TOYOBO Co., Ltd.: 200 (glass transition temperature: 67° C.); 600 (glass transition temperature: 47° C.); GK-360 (glass transition temperature: 56° C.); GK-810 (glass transition temperature: 46° C.); and GK-680 (glass transition temperature: 10° C.), and the like. “elitel” is a Japanese registered trademark of Unitika Ltd. “VYLON is a Japanese registered trademark of TOYOBO Co., Ltd., and “TOYOBO VYLON” is a U.S. registered trademark of TOYOBO Co., Ltd.

Some specific examples of commercially available epoxy-based resins are epoxy resins from the jER (registered trademark) series manufactured by MITSUBISHI CHEMICAL CORPORATION, including the basic solid types: 1001 (softening point [ball and ring method method]: 64° C., number average molecular weight Mn: about 900); 1002 (softening point [ball and ring method]: 78° C., number average molecular weight Mn: about 1200); 1003 (softening point [ball and ring method]: 89° C., number average molecular weight Mn: about 1300); 1055 (softening point [ball and ring method]: 93° C., number average molecular weight Mn: about 1600); 1004 (softening point [ball and ring method]: 97° C., number average molecular weight Mn: about 1650); 1004AF (softening point [ball and ring method]: 97° C., number average molecular weight Mn: about 1650); 1007 (softening point [ball and ring method]: 128° C., number average molecular weight Mn: about 2900); 1009 (softening point [ball and ring method]: 144° C., number average molecular weight Mn: about 3800); 1010 (number average molecular weight Mn: about 5500); 1003F (softening point [ball and ring method]: 96° C.); 1004F (softening point [ball and ring method]: 103° C.); 1005F and 1009F (softening point [ball and ring method]: 144° C.); 1004FS (softening point [ball and ring method]: 100° C.); 1006FS (softening point [ball and ring method]: 112° C.); and 1007FS (softening point [ball and ring method]: 124° C.). “jER” is a registered trademark of MITSUBISHI CHEMICAL CORPORATION.

Some specific examples of commercially available phenol-based resins include phenolic resins from the PHENOLITE (registered trademark) series manufactured by DIC Corporation: TD-2131 (softening point: 78-82° C.); TD-2106 (softening point: 88-95° C.); TD-2093 (softening point: 98-102° C.); TD-2090 (softening point: 117-123° C.), and the like, and phenolic resins from the SHONOL (registered trademark) series manufactured by AICA KOGYO CO., LTD.: BRG-555 (softening point: 66-72° C., melt viscosity: 0.3-0.5 Pa·s/125° C.); BRG-556 (softening point: 77-83° C., melt viscosity: 0.1-0.3 Pas/150° C.); BRG-557 (softening point: 82-88° C., melt viscosity: 0.2-0.4 Pa·s/150° C.); BRG-558 (softening point: 93-98° C., melt viscosity: 0.8-1.2 Pa·s/150° C.); CRG-951 (softening point: 93-99° C., melt viscosity: 0.2-0.8 Pa: s/150° C.); TAM-005 (softening point: 80-88° C., melt viscosity: 0.3-0.5 Pa·s/150° C.); and the like. “PHENOLITE” is a registered trademark of DIC corporation. “SHONOL” is a registered trademark of AICA KOGYO CO., LTD.

The polyvinyl alcohol-based resin is preferably a partially saponified polyvinyl alcohol resin having a hydrolysis degree less than or equal to 90, for example. Furthermore, the polyvinyl alcohol-based resin has a degree of polymerization less than or equal to 2000, for example, and preferably about 500. Some specific examples of commercially available polyvinyl alcohol-based resins include resins from the DENKA POVAL (registered trademark) series manufactured by Denka Company, Limited: B-05 (hydrolysis degree: 86.5-89.5 mol %, degree of polymerization: about 500, viscosity [4%, 20° C.]: 5.0-6.0 mPa s); B-17 (hydrolysis degree: 87.0-89.0 mol %, degree of polymerization: about 1600, viscosity [4%, 20° C.]: 21-25 mPa·s); B-20 (hydrolysis degree: 87.0-89.0 mol %, degree of polymerization: about 2000, viscosity [4%, 20° C.]: 27-33 mPa's); and the like, and resins from the KURARAY POVAL (registered trademark) series manufactured by Kuraray Co., Ltd.: 48-80 (hydrolysis degree: 78.5-80.5 mol %, viscosity [4%, 20° C.]: 45.0-51.0 mPa s); 3-88 (hydrolysis degree: 87.0-89.0 mol %, viscosity [4%, 20° C.]: 3.2-3.6 mPa·s); 5-88 (hydrolysis degree: 86.5-89.0 mol %, viscosity [4%, 20° C.]: 4.6-5.4 mPa·s); and the like. “DENLA POVAL” is a Japanese registered trademark of Denka Company Limited. “KURARY POVAL” is a registered trademark of Kuraray Co., Ltd.

The softening point of the polyamide resin used in the welding layer 70 is greater than or equal to 90° C., for example, and preferably greater than or equal to 110° C., and more preferably greater than or equal to 125° C. With the softening point in this range, the welding layer 70 can maintain high tack strength between the base material layer 48 and the first thermal transfer layer 50 with almost no softening at the relatively low temperature used in low-temperature transfers.

The welding layer 70 can be formed by applying a coating material in which the material for forming the welding layer 70 is dissolved or dispersed in any solvent to the front surface 53 of the base material layer 48, and then drying the coating material.

The thickness of the welding layer 70 can be set arbitrarily according to the specifications of the thermal transfer printer or the like, for example. The thickness of the welding layer 70 can be adjusted by the coating amount of the welding layer 70, for example. Expressed as the mass of solids per unit area, the coating amount of the welding layer 70 is greater than or equal to 0.1 g/m², for example, and preferably greater than or equal to 0.2 g/m². Expressed as the mass of solids per unit area, the coating amount of the welding layer 70 is less than or equal to 1.5 g/m², for example, and preferably less than or equal to 1.0 g/m². Expressed as the mass of solids per unit area, the coating amount of the welding layer 70 is greater than or equal to 0.1 g/m² and less than or equal to 1.5 g/m², for example, and preferably greater than or equal to 0.2 g/m² and less than or equal to 1.0 g/m².

The specific thickness of the welding layer 70 (before printing) may be greater than or equal to 0.05 μm and less than or equal to 1.5 μm, for example, and preferably greater than or equal to 0.2 μm and less than or equal to 1.0 μm. The thicknesses of the welding layer 70 can be verified from a scanning electron microscope (SEM) image, a transmission electron microscope (TEM) image, or the like of the thermal transfer recording medium 47, for example.

### (4) First Thermal Transfer Layer 50

The first thermal transfer layer 50 can be formed of any thermoplastic resin, for example. The first thermal transfer layer 50 is preferably formed using an epoxy resin as the thermoplastic resin with consideration for improving affinity and adhesion strength to the welding layer 70 and intermediate layer 51. Epoxy resins have excellent affinity and adhesion strength to thermoplastic elastomers forming the base material layer 48 and intermediate layer 51, which are made of a film of polyester such as PET. The first thermal transfer layer 50 can be formed using an epoxy resin in which a curing agent is not blended (is excluded) as the thermoplastic resin.

Some examples of epoxy resins include bisphenol A epoxy resins, bisphenol F epoxy resins, phenol novolac epoxy resins, cresol novolac epoxy resins, alicyclic epoxy resins, hydrogenated bisphenol A epoxy resins, hydrogenated bisphenol AD epoxy resins, aliphatic epoxy resins such as propylene glycol glycoxy ether and pentaerythritol polyglycidyl ether, epoxy resins obtained from aliphatic or aromatic amines and epichlorohydrin, epoxy resins obtained from aliphatic or aromatic carboxylic acids and epichlorohydrin, heterocyclic epoxy resins, spirocycle-containing epoxy resins, epoxy modified resins, brominated epoxy resins, and the like. While there are no particular restrictions on the epoxy resins, the following are some specific examples of various epoxy resins. These epoxy resins can be used alone or in a combination of two or more types.

The epoxy resin may be one of the basic solid types from the jER (registered trademark) series manufactured by MITSUBISHI CHEMICAL CORPORATION: 1001 (softening point [ball and ring method]: 64° C., number average molecular weight Mn: about 900); 1002 (softening point [ball and ring method]: 78° C., number average molecular weight Mn: about 1200); 1003 (softening point [ball and ring method]: 89° C., number average molecular weight Mn: about 1300); 1055 (softening point [ball and ring method]: 93° C., number average molecular weight Mn: about 1600); 1004 (softening point [ball and ring method]: 97° C., number average molecular weight Mn: about 1650); 1004AF (softening point [ball and ring method]: 97° C., number average molecular weight Mn: about 1650); 1007 (softening point [ball and ring method]: 128° C., number average molecular weight Mn: about 2900); 1009 (softening point [ball and ring method]: 144° C., number average molecular weight Mn: about 3800); 1010 (number average molecular weight Mn: about 5500); 1003F (softening point [ball and ring method]: 96° C.); 1004F (softening point [ball and ring method]: 103° C.); 1005F and 1009F (softening point [ball and ring method]: 144° C.); 1004FS (softening point [ball and ring method]: 100° C.); 1006FS (softening point [ball and ring method]: 112° C.); and 1007FS (softening point [ball and ring method]: 124° C.).

The softening point of the epoxy resin used in the first thermal transfer layer 50 is greater than or equal to 95° C., for example, and preferably greater than or equal to 110° C., and more preferably greater than or equal to 125° C.

The first thermal transfer layer 50 may contain an adhesive agent in addition to the epoxy resin. Including an adhesive agent can further improve affinity and adhesion strength to the welding layer 70 and intermediate layer 51. Some examples of adhesive agents include rubber-based adhesive agents, acrylic adhesive agents, silicone-based adhesive agents, vinyl alkyl ether-based adhesive agents, polyvinyl alcohol-based adhesive agents, polyvinylpyrrolidone-based adhesive agents, polyacrylamide-based adhesive agents, cellulose-based adhesive agents, and the like.

Acrylic adhesive agents are preferable as the adhesive agent in consideration for their affinity and compatibility with epoxy resins and ability to improve affinity and adhesion strength to the welding layer 70 and intermediate layer 51. While there are no particular restrictions on the acrylic adhesive agents, the following are some specific examples of various acrylic adhesive agents. These acrylic adhesive agents can be used alone or in a combination of two or more types.

Among the ORIBAIN (registered trademark) BPS (solvent-based) series manufactured by TOYOCHEM CO., LTD.: BPS 1109 (nonvolatile content: 39.5% by mass); BPS 3156D (nonvolatile content: 34% by mass); BPS 4429-4 (nonvolatile content: 45% by mass); BPS 4849-40 (nonvolatile content: 40% by mass); BPS 5160 (nonvolatile content: 33% by mass); BPS 5213K (nonvolatile content: 35% by mass); BPS 5215K (nonvolatile content: 39% by mass); BPS 5227-1 (nonvolatile content: 41.5% by mass); BPS 5296 (nonvolatile content: 37% by mass); BPS 5330 (nonvolatile content: 40% by mass); BPS 5375 (nonvolatile content: 45% by mass); BPS 5448 (nonvolatile content: 40% by mass); BPS 5513 (nonvolatile content: 44.5% by mass); BPS 5565K (nonvolatile content: 45% by mass); BPS 5669K (nonvolatile content: 46% by mass); BPS 5762K (nonvolatile content: 45.5% by mass); BPS 5896 (nonvolatile content: 37% by mass); BPS 5978 (nonvolatile content: 35% by mass); BPS 6074HTF (nonvolatile content: 52% by mass); BPS 6080TFK (nonvolatile content: 45% by mass); BPS 6130TF (nonvolatile content: 45.5% by mass); BPS 6153K (nonvolatile content: 25% by mass); BPS 6163 (nonvolatile content: 37% by mass); BPS 6231 (nonvolatile content: 56% by mass); BPS 6421 (nonvolatile content: 47% by mass); BPS 6430 (nonvolatile content: 33% by mass); BPS 6574 (nonvolatile content: 57% by mass); BPS 8170 (nonvolatile content: 36.5% by mass); and BPS HS-1 (nonvolatile content: 40% by mass). “ORIBAIN” is a registered trademark of TOYO INK SC HOLDINGS CO., LTD.

Among the solvent-based adhesive agents (removable type) manufactured by LION SPECIALTY CHEMICALS CO., LTD.: AS-325 (solid content concentration: 45% by mass); AS-375 (solid content concentration: 45% by mass); AS-409 (solid content concentration: 45% by mass); AS-417 (solid content concentration: 45% by mass); AS-425 (solid content concentration: 45% by mass); AS-455 (solid content concentration: 45% by mass); AS-665 (solid content concentration: 40% by mass); AS-1107 (solid content concentration: 43% by mass); and AS-4005 (solid content concentration: 45% by mass).

The acrylic adhesive agent used in the first thermal transfer layer 50 may be used in combination with a tackifier.

The purpose of a tackifier is to enhance the sharpness of the first thermal transfer layer 50, suppress excessive peeling, and improve the clarity of the recorded characters. Some examples of tackifiers include ester gums, terpene phenolic resins, rosin esters, and the like. While there are no particular restrictions on these tackifiers, the following are some specific examples of various tackifiers. These tackifiers can be used alone or in a combination of two or more types.

Among the terpene phenolic resins in the YS POLYESTER series manufactured by YASUHARA CHEMICAL CO., LTD: U130 (softening point: 130±5° C.); U115 (softening point: 115±5° C.); T160 (softening point: 160±5° C.); T145 (softening point: 145±5° C.); T130 (softening point: 130±5° C.); T115 (softening point: 115±5° C.); T100 (softening point: 100±5° C.); T80 (softening point: 80±5° C.); S145 (softening point: 145±5° C.); G150 (softening point: 150±5° C.); G125 (softening point: 125±5° C.); N125 (softening point: 125±5° C.); K125 (softening point: 125±5° C.); and TH130 (softening point: 130±5° C.).

Among the ester gums manufactured by ARAKAWA CHEMICAL INDUSTRIES, LTD.: AA-G (softening point [ball and ring method]: 82-88° C.); AA-L (softening point [ball and ring method]: 82-88° C.); AA-V (softening point [ball and ring method]: 82-95° C.); 105 (softening point [ball and ring method]: 100-110° C.); AT (viscosity: 20000-40000 mPa·s); H (softening point [ball and ring method]: 68-75° C.); and HP (softening point [ball and ring method]: greater than or equal to 80° C.).

Among the rosin esters in the Pensel (registered trademark) series manufactured by ARAKAWA CHEMICAL INDUSTRIES, LTD.: GA-100 (softening point [ball and ring method]: 100-110° C.); AZ (softening point [ball and ring method]: 95-105° C.); C (softening point [ball and ring method]: 117-127° C.); D-125 (softening point [ball and ring method]: 120-130° C.); D-135 (softening point [ball and ring method]: 130-140° C.); D-160 (softening point [ball and ring method]: 150-165° C.); and KK (softening point [ball and ring method]: greater than or equal to 165° C.). “Pensel” is a Japanese registered trademark of ARAKAWA CHEMICAL INDUSTRIES, LTD.

The softening point of the tackifier used in the first thermal transfer layer 50 is greater than or equal to 60° C., for example, and preferably less than or equal to 120° C.

The first thermal transfer layer 50 may contain any colorant. As the colorant, one or two or more types of colorants may be used, depending on the hue of the first thermal transfer layer 50. For example, the colorant may be a pigment. For example, pigments are preferred as the colorant used in the first thermal transfer layer 50 in consideration for improving weather resistance of the characters and the like. For example, carbon black is preferred as the pigment for coloring the first thermal transfer layer 50 black. While there are no particular restrictions on the carbon black, the following are some specific examples of types of carbon black. These carbon blacks can be used alone or in a combination of two or more types.

Manufactured by MITSUBISHI CHEMICAL CORPORATION: MA77 powder (long flow furnace [LFF], dibutyl phthalate [DBP] absorption number: 68 cm³/100 g); MA7 powder (LFF, DBP absorption number: 66 cm³/100 g); MA7 granules (LFF, DBP absorption number: 65 cm³/100 g); MA8 powder (LFF, DBP absorption number: 57 cm³/100 g); MA8 granules (LFF, DBP absorption number: 51 cm³/100 g); MA11 powder (LFF, DBP absorption number: 64 cm³/100 g); MA100 powder (LFF, DBP absorption number: 100 cm³/100 g); MA100 granules (LFF, DBP absorption number: 95 cm³/100 g); MA100R powder (LFF, DBP absorption number: 100 cm³/100 g); MA100R granules (LFF, DBP absorption number: 95 cm³/100 g); MA100S powder (LFF, DBP absorption number: 100 cm³/100 g); MA230 powder (LFF, DBP absorption number: 113 cm³/100 g); MA220 powder (LFF, DBP absorption number: 93 cm³/100 g); and MA14 powder (LFF, DBP absorption number: 73 cm³/100 g).

Manufactured by MITSUBISHI CHEMICAL CORPORATION: #3030B (furnace method, DBP absorption number: 130 cm³/100 g); #3040B (furnace method, DBP absorption number: 114 cm³/100 g); #3050B (furnace method, DBP absorption number: 175 cm³/100 g); #3230B (furnace method, DBP absorption number: 140 cm³/100 g); #3350B (furnace method, DBP absorption number: 164 cm³/100 g); and #3400B (furnace method, DBP absorption number: 175 cm³/100 g).

Within the TOKABLACK (registered trademark) series manufactured by TOKAI CARBON CO., LTD.: #5500 (furnace method, DBP absorption number: 155 cm³/100 g); #4500 (furnace method, DBP absorption number: 168 cm³/100 g); #4400 (furnace method, DBP absorption number: 135 cm³/100 g); and #4300 (furnace method, DBP absorption number: 142 cm³/100 g). “TOKABLACK” is a registered trademark of TOKAI CARBON CO., LTD.

Within the PRINTEX (registered trademark) series manufactured by ORION ENGINEERED CARBONS: L (furnace method, DBP absorption number: 120 cm³/100 g); and L6 (furnace method, DBP absorption number: 126 cm³/100 g). “PRINTEX” is a registered trademark of ORION ENGINEERED CARBONS GMBH.

Within the CONDUCTEX (registered trademark) series manufactured by Birla Carbon: 975 (furnace method, DBP absorption number: 170 cm³/100 g); and SC (furnace method, DBP absorption number: 115 cm³/100 g).

Within the VULCAN (registered trademark) series manufactured by CABOT CORPORATION: XC72 (furnace method, DBP absorption number: 174 cm³/100 g); and 9A32 (furnace method, DBP absorption number: 114 cm³/100 g), and within the BLACK PEARLS (registered trademark) series also manufactured by CABOT CORPORATION: 3700 (furnace method, DBP absorption number: 111 cm³/100 g). “VULCAN” is a registered trademark of CABOT CORPORATION. “BLACK PEARLS” is a registered trademark of CABOT CORPORATION.

Within the DENKA BLACK (registered trademark) series manufactured by Denka Company Limited: DENKA BLACK granule products (acetylene method, DBP absorption number: 160 cm³/100 g); FX-35 (acetylene method, DBP absorption number: 220 cm³/100 g); and HS-100 (acetylene method, DBP absorption number: 140 cm³/100 g). “DENKA BLACK” is a registered trademark of Denka Company Limited.

Within the KETJENBLACK (registered trademark) series manufactured by LION SPECIALTY CHEMICALS CO., LTD.: EC300J (gasification method, DBP absorption number: 360 cm³/100 g); and EC600JD (gasification method, DBP absorption number: 495 cm³/100 g). “KETJENBLACK” is a registered trademark of AKZO NOBEL CHEMICALS B.V.

There is no particular restriction on the ratios of components in the first thermal transfer layer 50. The ratio of acrylic adhesive agent to 100 parts by mass of epoxy resin is greater than or equal to 30 parts by mass, for example, and preferably greater than or equal to 40 parts by mass. The ratio of acrylic adhesive agent to 100 parts by mass of epoxy resin is less than or equal to 150 parts by mass, for example, and preferably less than or equal to 100 parts by mass. Thus, the ratio of acrylic adhesive agent to 100 parts by mass of epoxy resin is greater than or equal to 30 parts by mass and less than or equal to 150 parts by mass, for example, and preferably greater than or equal to 40 parts by mass and less than or equal to 100 parts by mass.

The ratio of tackifier to 100 parts by mass of epoxy resin is greater than or equal to 3 parts by mass, for example, and preferably greater than or equal to 5 parts by mass. The ratio of tackifier to 100 parts by mass of epoxy resin is less than or equal to 150 parts by mass, for example, and preferably less than or equal to 100 parts by mass. Thus, the ratio of tackifier to 100 parts by mass of epoxy resin is greater than or equal to 3 parts by mass and less than or equal to 150 parts by mass, for example, and preferably greater than or equal to 5 parts by mass and less than or equal to 100 parts by mass.

The ratio of colorant such as carbon black to 100 parts by mass of epoxy resin is greater than or equal to 100 parts by mass, for example, and preferably greater than or equal to 130 parts by mass. The ratio of colorant to 100 parts by mass of epoxy resin is less than or equal to 230 parts by mass, for example, and preferably less than or equal to 200 parts by mass. Thus, the ratio of colorant to 100 parts by mass of epoxy resin is greater than or equal to 100 parts by mass and less than or equal to 230 parts by mass, for example, and preferably greater than or equal to 130 parts by mass and less than or equal to 200 parts by mass.

Among components of the first thermal transfer layer 50, for components that are dissolved or dispersed in an arbitrary solvent and supplied in a liquid form, their blending amount should be adjusted so that the effective ratios of the components are within the above ranges (the same applies hereafter).

The first thermal transfer layer 50 can be formed by applying a coating material in which each of the above components has been dissolved or dispersed in any solvent directly on the welding layer 70 and then drying the coating material. In the present disclosure, different colors are used for characters recorded on the printing tape 2, as illustrated in FIGS. 5A and 5B. To achieve these color differences, the first thermal transfer layer 50 is preferably formed directly on the welding layer 70 in consideration for making adjustments to the adhesion strength between the first thermal transfer layer 50 and the welding layer 70 and other layers.

The thickness of the first thermal transfer layer 50 can be set arbitrarily according to the specifications of the thermal transfer printer or the like, for example. The thickness of the first thermal transfer layer 50 can be adjusted by the coating amount of the first thermal transfer layer 50.

Expressed as the mass of solids per unit area, the coating amount of the first thermal transfer layer 50 is greater than or equal to 0.1 g/m², for example, and preferably greater than or equal to 0.5 g/m². Expressed as the mass of solids per unit area, the coating amount of the first thermal transfer layer 50 is less than or equal to 3.0 g/m², for example, and preferably less than or equal to 2.5 g/m². Expressed as the mass of solids per unit area, the coating amount of the first thermal transfer layer 50 is greater than or equal to 0.1 g/m² and less than or equal to 3.0 g/m², for example, and preferably greater than or equal to 0.5 g/m² and less than or equal to 2.5 g/m².

The specific thickness of the first thermal transfer layer 50 (before printing) is greater than or equal to 0.05 μm, for example, and preferably greater than or equal to 0.5 μm. The thickness of the first thermal transfer layer 50 is less than or equal to 3.0 μm, for example, and preferably less than or equal to 2.5 μm. The thickness of the first thermal transfer layer 50 may be greater than or equal to 0.05 μm and less than or equal to 3.0 μm, for example, and preferably greater than or equal to 0.5 μm and less than or equal to 2.5 μm. The thicknesses of the first thermal transfer layer 50 can be verified from a scanning electron microscope (SEM) image, a transmission electron microscope (TEM) image, or the like of the thermal transfer recording medium 47, for example.

### (5) Intermediate Layer 51

The intermediate layer 51 includes a thermoplastic elastomer. In particular, the intermediate layer 51 is preferably formed of only thermoplastic elastomers. The thermoplastic elastomers forming the intermediate layer 51 preferably include at least one type from among thermoplastic styrenic elastomers and thermoplastic acetate ester-based elastomers.

Some examples of thermoplastic styrenic elastomers include a styrene-butadiene-styrene (SBS) block copolymer, a styrene-ethylene-butylene-styrene (SEBS) block copolymer, a styrene-ethylene-propylene-styrene (SEPS) block copolymer, a styrene-ethylene-ethylene-propylene-styrene (SEEPS) block copolymer, and a styrene-isoprene-styrene (SIS) block copolymer. Examples of thermoplastic acetate ester-based elastomers include an ethylene-vinyl acetate (EVA) copolymer and the like.

The styrene content in the thermoplastic elastomer contained in the intermediate layer 51 is greater than or equal to 10% by mass and less than or equal to 70% by mass, for example, and preferably greater than or equal to 15% by mass and less than or equal to 50% by mass. If the styrene content is too high, the rubber elasticity of the intermediate layer 51 will decrease, which may result in, during high-temperature transfers, the inability to maintain the adhesion strength to the first thermal transfer layer 50 and second thermal transfer layer 52 or making the hues of the characters appear cloudy. If the styrene content is too low, the rubber elasticity of the intermediate layer 51 will become too great, which may prevent the second thermal transfer layer 52 from peeling off during the low-temperature transfers, causing cloudiness of the hues of the characters.

The thermoplastic elastomer contained in the intermediate layer 51 has a melt mass-flow rate (hereinafter simply called the “MFR”) less than or equal to 1000 g/10 min, for example, and preferably less than or equal to 400 g/10 min. The MFR may be found at a temperature 190° C. and a load of 2.16 kg according to the measurement method defined in ISO 1133-1:2011, for example. Hereinafter, unless otherwise indicated, the conditions for measuring MFR will be at a temperature of 190° C. and a load of 2.16 kg.

Thermoplastic elastomers with an MFR exceeding 400 g/10 min tend to have too strong an affinity with the second thermal transfer layer 52. As a consequence, the second thermal transfer layer 52 may not be able to peel off during low-temperature transfers and cloudiness of the colors of characters may occur. Additionally, the entire thermal transfer recording medium 47, i.e., the base material layer 48, welding layer 70, first thermal transfer layer 50, intermediate layer 51, and second thermal transfer layer 52, may adhere to the printing surface 31 of the printing tape 2. Thermoplastic elastomers with an MFR exceeding 400 g/10 min have low melt viscosity and high fluidity. Therefore, during low-temperature transfers, the adhesion strength to the first thermal transfer layer 50 and second thermal transfer layer 52 may not be maintained, or cloudiness of the hues of characters may occur.

Conversely, thermoplastic elastomers having an MFR less than or equal to 400 g/10 min can suppress such problems that arise when using thermoplastic elastomers with an MFR exceeding 400 g/10 min. Even during continuous thermal transfer recording, hues on the printing surface 31 of the printing tape 2 can be clearly separated into two colors with little cloudiness of hues so that characters can be recorded with excellent clarity while avoiding the occurrence of excessive peeling. In consideration for further improving these effects, the MFR of the thermoplastic elastomer is preferably less than or equal to 2.5 g/10 min, and particular less than or equal to 2.3 g/10 min.

There is no particular restriction on the lower limit of the MFR. Even thermoplastic elastomers for which measurement results at the temperature of 190° C. and load of 2.16 kg described above are “No Flow” can be used. While there are no particular restrictions on these thermoplastic elastomers, the following are some specific examples of various thermoplastic elastomers. These thermoplastic elastomers can be used alone or in a combination of two or more types.

Within the SEBS of the TUFTEC (registered trademark) series manufactured by Asahi Kasei Corporation: H1521 (MFR: 2.3 g/10 min); H1051 (MFR: less than 0.8 g/10 min); H1052 (MFR: less than 13.0 g/10 min); H1272 (MFR: No Flow); P1083 (MFR: 3.0 g/10 min); P1500 (MFR: 4.0 g/10 min); P5051 (MFR: 3.0 g/10 min); and P2000 (MFR: 3.0 g/10 min). “TUFTEC” is a registered trademark of ASAHI KASEI KABUSHIKI KAISHA.

Within the SBS of the TUFPRENE (registered trademark) series manufactured by Asahi Kasei Corporation: A (MFR: 2.6 g/10 min); 125 (MFR: 4.5 g/10 min); and 126S (MFR: 4.5 g/10 min). “TUFPRENE” is a registered trademark of ASAHI KASEI KABUSHIKI KAISHA.

Within the SBS of the ASAPRENE (registered trademark) T series manufactured by Asahi Kasei Corporation: T-411 (MFR: No Flow); T-432 (MFR: No Flow); T-437 (MFR: No Flow); T-438 (MFR: No Flow); and T-439 (MFR: No Flow). “ASAPRENE” is a registered trademark of ASAHI KASEI KABUSHIKI KAISHA.

Within the SEPS of the SEPTON (registered trademark) series manufactured by Kuraray Co., Ltd.: 2002 (MFR: 70 g/10 min); 2004F (MFR: 5 g/10 min); 2005 (MFR: No Flow); 2006 (MFR: No Flow); 2063 (MFR: 7 g/10 min); and 2104 (MFR: 0.4 g/10 min). The MFR measurement conditions for these SEPS were all at a temperature of 230° C. and a load of 2.16 kg. “SEPTON” is a registered trademark of Kuraray Co., Ltd.

Within the SEEPS of the SEPTON (registered trademark) series manufactured by Kuraray Co., Ltd.: 4033 (MFR: <0.1 g/10 min); 4044 (MFR: No Flow); 4055 (MFR: No Flow); 4077 (MFR: No Flow); and 4099 (MFR: No Flow). The MFR measurement conditions for these SEEPS were all at a temperature of 230° C. and a load of 2.16 kg.

Within the vinyl-bond rich SIS in the HYBRAR (registered trademark) series manufactured by Kuraray Co., Ltd.: 5125 (MFR: 4 g/10 min); and 5127 (MFR: 5 g/10 min). “HYBRAR” is a registered trademark of Kuraray Co., Ltd.

Within the EVA of the Ultrathene (registered trademark) series manufactured by Tosoh Corporation: 514R (MFR: 0.41 g/10 min); 515 (MFR: 2.5 g/10 min); 510 (MFR: 2.5 g/10 min); 510F (MFR: 2.5 g/10 min); 520F (MFR: 2.0 g/10 min); 540 (MFR: 3.0 g/10 min); 540F (MFR: 3.0 g/10 min); 537 (MFR: 8.5 g/10 min); 537L (MFR: 8.5 g/10 min); 537S-2 (MFR: 8.5 g/10 min); 541 (MFR: 9.0 g/10 min); 541L (MFR: 9.0 g/10 min); 530 (MFR: 75 g/10 min); 526 (MFR: 25 g/10 min); 630 (MFR: 1.5 g/10 min); 631 (MFR: 1.5 g/10 min); 636 (MFR: 2.5 g/10 min); 625 (MFR: 14 g/10 min); 626 (MFR: 3.0 g/10 min); 627 (MFR: 0.8 g/10 min); 633 (MFR: 20 g/10 min); 635 (MFR: 2.4 g/10 min); 640 (MFR: 2.8 g/10 min); 634 (MFR: 4.3 g/10 min); 680 (MFR: 160 g/10 min); 681 (MFR: 350 g/10 min); 751 (MFR: 5.7 g/10 min); 710 (MFR: 18 g/10 min); 720 (MFR: 150 g/10 min); 722 (MFR: 400 g/10 min); 750 (MFR: 30 g/10 min); 752 (MFR: 60 g/10 min); and 760 (MFR: 70 g/10 min). “Ultrathene” is a Japanese registered trademark of Tosoh Corporation.

The intermediate layer 51 can be formed, for example, by applying a coating material in which the forming materials for the intermediate layer 51 including at least a thermoplastic elastomer are dissolved or dispersed in any solvent onto the first thermal transfer layer 50 and then drying the coating material.

The thickness of the intermediate layer 51 can be set arbitrarily according to the specifications of the thermal transfer printer or the like, for example. The thickness of the intermediate layer 51 can be adjusted by the coating amount of the intermediate layer 51. Expressed as the mass of solids per unit area, the coating amount of the intermediate layer 51 is greater than or equal to 0.1 g/m², for example, and preferably greater than or equal to 0.2 g/m². Expressed as the mass of solids per unit area, the coating amount of the intermediate layer 51 is less than or equal to 2.0 g/m², for example, and preferably less than or equal to 1.5 g/m². Expressed as the mass of solids per unit area, the coating amount of the intermediate layer 51 is greater than or equal to 0.1 g/m² and less than or equal to 2.0 g/m², for example, and preferably greater than or equal to 0.2 g/m² and less than or equal to 1.5 g/m².

The specific thickness of the intermediate layer 51 (before printing) is greater than or equal to 0.05 μm, for example, and preferably greater than or equal to 0.2 μm. The thickness of the intermediate layer 51 is less than or equal to 2.0 μm, for example, and preferably less than or equal to 1.5 μm. The thickness of the intermediate layer 51 may be greater than or equal to 0.05 μm and less than or equal to 2.0 μm, for example, and preferably greater than or equal to 0.2 μm and less than or equal to 1.5 μm. The thickness of the intermediate layer 51 can be verified from a scanning electron microscope (SEM) image, a transmission electron microscope (TEM) image, or the like of the thermal transfer recording medium 47, for example.

Due to limitations in coating precision, the thickness of the intermediate layer 51 may differ, depending on the measurement position. The coating amount and thickness of the intermediate layer 51 described above may contain such errors. For example, an intermediate layer 51 formed with a coating amount of 0.2 g/m² may have areas whose thickness is equivalent to a layer formed with a coating amount of 0.1 g/m², depending on the measurement position.

### (6) Second Thermal Transfer Layer 52

The second thermal transfer layer 52 can be formed of any thermoplastic resin, for example. Some examples of thermoplastic resins that can be used in the second thermal transfer layer 52 include epoxy resins, polyester resins, polyolefin resins, and the like. Any thermoplastic resin can be selected as appropriate according to the forming materials used for the printing tape 2 and the like. When the first thermal transfer layer 50 is formed of epoxy resin, the second thermal transfer layer 52 is preferably formed of epoxy resin, as well.

Forming the second thermal transfer layer 52 of epoxy resin can balance the adhesion strength of the first thermal transfer layer 50 relative to the welding layer 70 and intermediate layer 51 with the adhesion strength of the second thermal transfer layer 52 relative to the printing tape 2. This enables good separation between the first thermal transfer layer 50 and intermediate layer 51 on the base material layer 48 side and the second thermal transfer layer 52 on the printing tape 2 side during low-temperature transfers. Some examples of epoxy resins include any of the various epoxy resins given as examples of the epoxy resins for the first thermal transfer layer 50. These epoxy resins can be used alone or in a combination of two or more types.

The second thermal transfer layer 52 may contain wax in addition to the thermoplastic resin. The inclusion of wax enables good separation of the first thermal transfer layer 50 and intermediate layer 51 on the base material layer 48 side and the second thermal transfer layer 52 on the printing tape 2 side during low temperature transfers.

Wax used for the second thermal transfer layer 52 may be any wax that has affinity or compatibility with thermoplastic resins such as epoxy resins. For example, natural waxes such as carnauba wax, paraffin wax, and microcrystalline wax; and synthetic waxes such as Fischer-Tropsch waxes can be used. While there are no particular restrictions on these waxes, some examples include: carnauba waxes No. 1 flakes, No. 2 flakes, No. 3 flakes, No. 1 powder, and No. 2 powder (all with a melting point of 80-86° C.) manufactured by TOYOCHEM CO., LTD.; paraffin waxes EMUSTAR-1155 (melting point: 69° C.), EMUSTAR-0135 (melting point: 60° C.), EMUSTAR-0136 (melting point: 60° C.), and the like manufactured by Nippon Seiro Co., Ltd.; microcrystalline waxes EMUSTAR-0001 (melting point: 84° C.), EMUSTAR-042X (melting point: 84° C.), and the like manufactured by Nippon Seiro Co., Ltd.; and Fischer-Tropsch waxes FNP-0090 (congealing point: 90° C.), SX80 (congealing point: 83° C.), FT-0165 (melting point: 73° C.), FT-0070 (melting point: 72° C.), and the like manufactured by Nippon Seiro Co., Ltd. These waxes can be used alone or in a combination of two or more types.

The second thermal transfer layer 52 may contain any colorant. As the colorant, one or two or more types of colorants may be used, depending on the hue of the second thermal transfer layer 52. For example, the colorant may be a pigment. For example, pigments are preferred as the colorant used in the second thermal transfer layer 52 in consideration for improving weather resistance of the characters and the like. For example, the following various red pigments are examples of pigments that can be used to color the second thermal transfer layer 52 red. These red pigments can be used alone or in a combination of two or more types.

C.I. Pigment Red: 5; 7; 9; 12; 48 (Ca); 48 (Mn); 49; 52; 53; 53:1; 57 (Ca); 57:1; 97; 112; 122; 123; 149; 168; 177; 178; 179; 184; 202; 206; 207; 209; 242; 254; and 255.

There are no particular restrictions on the ratios of components in the second thermal transfer layer 52. The ratio of wax to 100 parts by mass of epoxy resin is greater than or equal to 3 parts by mass, for example, and preferably greater than or equal to 5 parts by mass. The ratio of wax to 100 parts by mass of epoxy resin is less than or equal to 11 parts by mass, for example, and preferably less than or equal to 9 parts by mass. Thus, the ratio of wax to 100 parts by mass of epoxy resin is greater than or equal to 3 parts by mass and less than or equal to 11 parts by mass, for example, and preferably greater than or equal to 5 parts by mass and less than or equal to 9 parts by mass.

The ratio of colorant such as a red pigment to 100 parts by mass of epoxy resin is greater than or equal to 70 parts by mass, for example, and preferably greater than or equal to 80 parts by mass. The ratio of colorant such as a red pigment to 100 parts by mass of epoxy resin is less than or equal to 140 parts by mass, for example, and preferably less than or equal to 120 parts by mass.

Thus, the ratio of colorant such as a red pigment to 100 parts by mass of epoxy resin is greater than or equal to 70 parts by mass and less than or equal to 140 parts by mass, for example, and preferably greater than or equal to 80 parts by mass and less than or equal to 120 parts by mass.

The second thermal transfer layer 52 can be formed by applying a coating material in which each of the above components has been dissolved or dispersed in any solvent on the intermediate layer 51 and then drying the coating material, for example.

The thickness of the second thermal transfer layer 52 can be set arbitrarily according to the specifications of the thermal transfer printer or the like, for example. The thickness of the second thermal transfer layer 52 can be adjusted by the coating amount of the second thermal transfer layer 52, for example. Expressed as the mass of solids per unit area, the coating amount of the second thermal transfer layer 52 is greater than or equal to 0.2 g/m², for example, and preferably greater than or equal to 1.0 g/m². Expressed as the mass of solids per unit area, the coating amount of the second thermal transfer layer 52 is less than or equal to 7.0 g/m², for example, and preferably less than or equal to 5.0 g/m². Expressed as the mass of solids per unit area, the coating amount of the second thermal transfer layer 52 is greater than or equal to 0.2 g/m² and less than or equal to 7.0 g/m², for example, and preferably greater than or equal to 1.0 g/m² and less than or equal to 5.0 g/m².

The specific thickness of the second thermal transfer layer 52 (before printing) is greater than or equal to 0.05 μm, for example, and preferably greater than or equal to 1.0 μm. The thickness of the second thermal transfer layer 52 is less than or equal to 7.0 μm, for example, and preferably less than or equal to 5.0 μm. The thickness of the second thermal transfer layer 52 may be greater than or equal to 0.05 μm and less than or equal to 7.0 μm, for example, and preferably greater than or equal to 1.0 μm and less than or equal to 5.0 μm. The thickness of the second thermal transfer layer 52 can be verified from a scanning electron microscope (SEM) image, a transmission electron microscope (TEM) image, or the like of the thermal transfer recording medium 47, for example.

Thermal transfer may occur in the thermal transfer recording medium 47 at a relatively low temperature when the amount of energy applied to the thermal head 6 (see FIGS. 1 and 3) is set to a low level, for example. In this case, the second thermal transfer layer 52 in this embodiment softens and its adhesion strength to the base material layer 48 decreases. At the same time, the adhesion strength between the first thermal transfer layer 50 and second thermal transfer layer 52 decreases. Since the welding layer 70 has a high softening point, the welding layer 70 softens very little at this time and maintains a strong adhesion strength between the base material layer 48 and first thermal transfer layer 50. As a result, a reverse transfer occurs during thermal transfer in which the first thermal transfer layer 50 and intermediate layer 51 remain on the base material layer 48 side while only the second thermal transfer layer 52 is thermally transferred onto the printing surface 31 of the printing tape 2. Therefore, the characters recorded on the printing surface 31 of the printing tape 2 will be the hue of the second thermal transfer layer 52, e.g., red.

On the other hand, thermal transfer may occur in the thermal transfer recording medium 47 at a higher temperature when the amount of energy applied to the thermal head 6 is set to a higher level. In this case, the welding layer 70 is further softened, greatly decreasing its adhesion strength to the base material layer 48, for example. As a result, the entire thermal transfer layer, i.e., the welding layer 70, first thermal transfer layer 50, intermediate layer 51, and second thermal transfer layer 52, are thermally transferred together onto the printing surface 31 of the printing tape 2. The characters recorded on the printing surface 31 of the printing tape 2 will be the hue of the first thermal transfer layer 50, which occupies the outermost layer after transfer, e.g., black.

As a result, a general-purpose thermal transfer printer that supports two-color recording can be used to record patterns in two colors, e.g., black and red.

Therefore, according to the present disclosure, use of a general-purpose thermal transfer printer that supports two-color recording can clearly separate recorded colors into two colors so that characters can be recorded with excellent clarity and little cloudiness of hues while avoiding the occurrence of excessive peeling, even during continuous thermal transfer recording.

### [Introduction of a Welding Layer 70 Based on Irreversible Changes in Strength]

FIG. 6 illustrates a thermal transfer recording medium 47 including a welding layer 70 as one example of a thermal transfer recording medium (an ink ribbon) capable of simultaneously recording characters in at least two colors with good clarity.

The welding layer 70 includes at least one type of resin selected from the group consisting of polyamide-based resins, polyester-based resins, epoxy-based resins, phenol-based resins, and polyvinyl alcohol-based resins as a specific chemical composition. The inventors of the present application studied and implemented thermal transfer recording media that exhibit similar effects from different perspectives, and this will be described below in detail. Simply put, while FIG. 6 focuses on the chemical composition of components in the welding layer 70, the following description will focus on irreversible changes in interlayer bonding strengths effected by controlling the attained temperature in the thermal transfer recording medium 47.

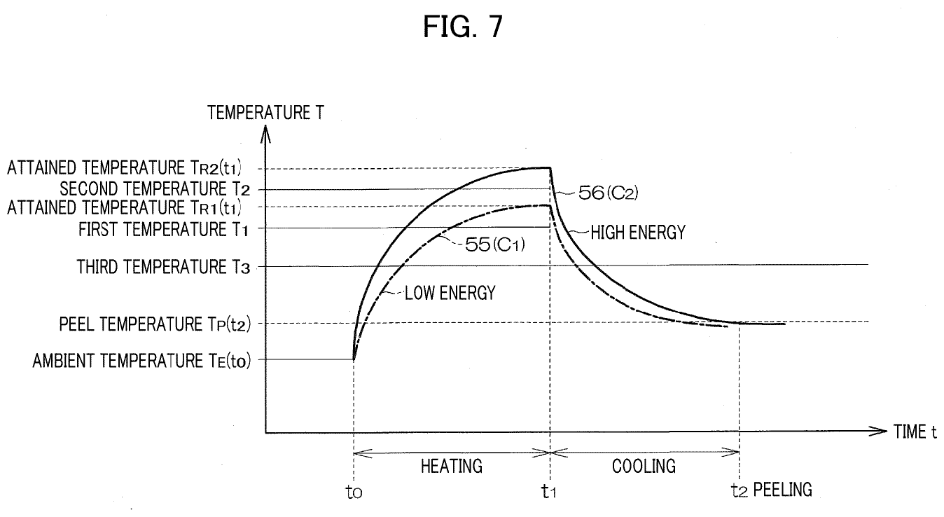

FIG. 7 is a diagram illustrating the relationship between elapsed time and the attained temperature of the thermal transfer recording medium 47 during the heating process and cooling process illustrated in FIGS. 1 through 4A and 4B.

The horizontal axis in FIG. 7 represents the elapsed time during a printing process on the printing device 1 where to denotes the printing start time, t₁ denotes the time at which the thermal head 6 ends heating, and t₂ denotes the time that the thermal transfer recording medium 47 arrives at the ink ribbon peeling member 13. The vertical axis in FIG. 7 represents the attained temperature of the thermal transfer recording medium 47. The attained temperature of the thermal transfer recording medium 47 can be defined as the temperature of the thermal transfer recording medium 47 that varies due to external factors. Examples of these external factors may include heating by the thermal head 6 and natural cooling of the thermal transfer recording medium 47 during conveyance.

Referring to FIG. 7, the printing device 1 can control the attained temperature of the thermal transfer recording medium 47 by controlling the temperature output (temperature energy) from the thermal head 6 with the control circuit 22. For example, a relatively low first energy amount is applied to the thermal head 6 in the heating process. The temperature of the thermal transfer recording medium 47 in this case follows a first temperature curve 55 depicted with a one-dot chain line increasing exponentially from an environmental temperature (e.g., room temperature) T_{E} around the thermal transfer recording medium 47 and reaching a temperature T_{R1}.

The attained temperature T_{R1} may be defined as a temperature greater than or equal to a first temperature T1 and less than or equal to a second temperature T2.

For example, the first temperature T₁ is greater than or equal to 60° C. and less than or equal to 100° C., and preferably greater than or equal to 70° C. and less than or equal to 90° C. For example, the second temperature T2 is greater than or equal to 80° C. and less than or equal to 180° C., and preferably greater than or equal to 130° C. and less than or equal to 150° C. The attained temperature T_{R1} can be set as needed according to the method by which the printing device 1 being used sets output from the thermal head 6. For example, the attained temperature may be set in relation to quantitative parameters such as the voltage or current supplied to the heating element 20 of the thermal head 6, the energizing time, and the like. Alternatively, the attained temperature may be set in relation to a relative numerical value relative to a predetermined reference value (e.g., a pre-energizing value of 0 [zero]).

In the heating process, on the other hand, a second energy amount higher than the first energy amount is applied to the thermal head 6. The temperature of the thermal transfer recording medium 47 in this case follows a second temperature curve 56 depicted by a solid line increasing exponentially from the environmental temperature T_{E} and reaching a temperature T_{R2}. The attained temperature T_{R2} may be defined as a temperature exceeding the second temperature T2.

After the heating process, the thermal transfer recording medium 47 cools naturally in the section leading up to the ink ribbon peeling member 13 (see FIGS. 3 and 4A and 4B). In the cooling process, the temperature of the thermal transfer recording medium 47 decreases exponentially from the attained temperature T_{R1} and attained temperature T_{R2} and reaches a temperature T_{P}. The temperature T_{P} at this time is the temperature at which a portion of the thermal transfer recording medium 47 is peeled off by the ink ribbon peeling member 13 and may be defined as the peel temperature T_{P}. The peel temperature T_{P} is preferably less than or equal to a third temperature T₃. The third temperature T₃ is lower than the first temperature T₁ (i.e., the first temperature T₁ is greater than the third temperature T₃) and is greater than or equal to 40° C. and less than or equal to 90° C., for example, and preferably greater than or equal to 60° C. and less than or equal to 80° C. The magnitude of the first temperature T₁, second temperature T₂, and third temperature T₃ can be set appropriately within ranges required for transferring ink onto the printing tape 2 with consideration for the chemical composition and properties of the ink of the thermal transfer recording medium 47.

Whether heating is controlled according to the first temperature curve 55 or second temperature curve 56 during the heating process, the temperature curves of the thermal transfer recording medium 47 in the cooling process (the cooling curves) ultimately converge at a fixed temperature. Therefore, the peel temperature T_{P} for the first temperature curve 55 and second temperature curve 56 can be made approximately the same by ensuring a lengthy duration of the cooling period (t₁→t₂). For example, the length of the cooling process can be increased by increasing the distance between the thermal head 6 and ink ribbon peeling member 13 (a peeling distance L₁ in FIG. 1). The state of the thermal transfer recording medium 47 after undergoing the heating process and cooling process according to the temperature changes indicated by the first temperature curve 55 in FIG. 7, for example, may be defined as a first state C₁. On the other hand, the state of the thermal transfer recording medium 47 after undergoing the heating process and cooling process according to the temperature changes indicated by the second temperature curve 56 in FIG. 7 may be defined as a second state C₂.

By controlling the temperature output (temperature energy) from the thermal head 6 in this way, the printing device 1 can modify the attained temperatures of the thermal transfer recording medium 47 in various ways during the process from the start of the heating process to the end of the cooling process, while keeping the starting temperature (the environmental temperature T_{E}) and the final temperature (the peel temperature T_{P}) constant. In consideration of this temperature control, the bonding strengths between the various layers of the thermal transfer recording medium 47 are expected to be controlled by controlling the temperature output from the thermal head 6 in accordance with the properties of the base material layer 48, backing layer 49, welding layer 70, first thermal transfer layer 50, intermediate layer 51, and second thermal transfer layer 52 in the thermal transfer recording medium 47 of FIG. 6, for example.

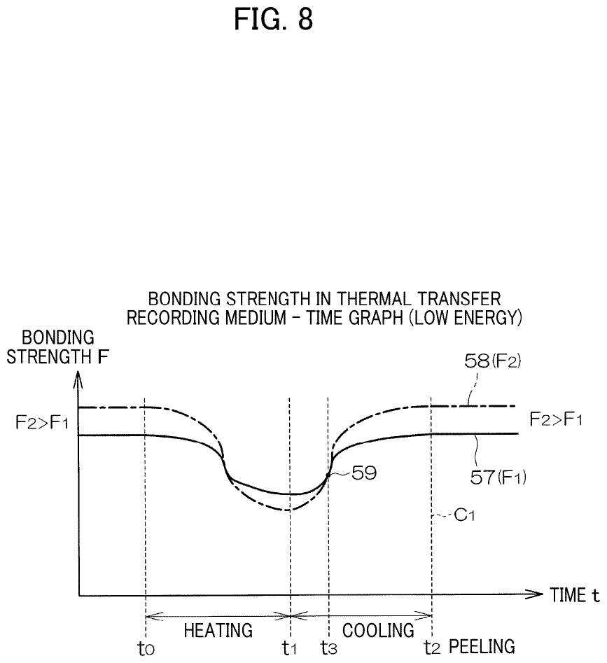

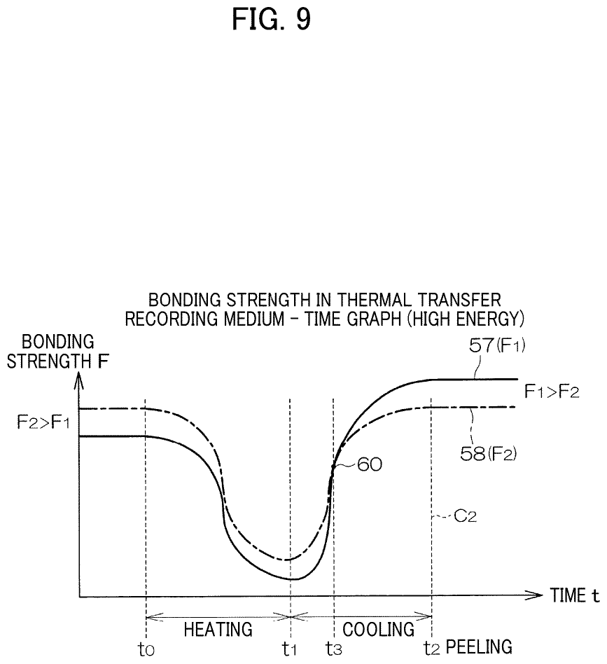

FIGS. 8 and 9 are diagrams illustrating the relationship between elapsed time and interlayer bonding strengths within the thermal transfer recording medium 47 during the heating process and cooling process. FIG. 8 shows changes in bonding strengths F when the temperature of the thermal transfer recording medium 47 is varied according to the first temperature curve 55 in FIG. 7. FIG. 9 shows changes in the bonding strengths F when the temperature of the thermal transfer recording medium 47 is varied according to the second temperature curve 56 in FIG. 7.

The horizontal axis in each of FIGS. 8 and 9 represents the elapsed time during a printing process on the printing device 1, where to denotes the printing start time, t₁ denotes the time at which the thermal head 6 ends heating, and t₂ denotes the time that the thermal transfer recording medium 47 arrives at the ink ribbon peeling member 13. The vertical axis in each of FIGS. 8 and 9 represents the magnitudes of bonding strengths between layers of the thermal transfer recording medium 47.

In FIGS. 8 and 9, a first bonding strength F₁ between the first thermal transfer layer 50 and second thermal transfer layer 52 of the thermal transfer recording medium 47 is indicated by a first bonding strength curve 57 depicted with a solid line. Furthermore, a second bonding strength F₂ between the base material layer 48 and first thermal transfer layer 50 is indicated by a second bonding strength curve 58 depicted with a one-dot chain line. The first bonding strength F₁ may include the force by which the bonding between the intermediate layer 51 and second thermal transfer layer 52 breaks, the force by which a breakage occurs within the second thermal transfer layer 52, and the force by which a breakage occurs within the intermediate layer 51. If a mixed layer is formed by melting and mixing the components of the first thermal transfer layer 50 and intermediate layer 51, the first bonding strength F₁ may include the force by which the bonding between the mixed layer and the second thermal transfer layer 52 breaks. The second bonding strength F₂ may include the force by which the bonding between the base material layer 48 and welding layer 70 breaks, the force by which the bonding between the welding layer 70 and first thermal transfer layer 50 breaks, the force by which a breakage occurs within the first thermal transfer layer 50, and the force by which a breakage occurs within the welding layer 70.

Referring to FIGS. 8 and 9, both the first bonding strength F₁ and second bonding strength F₂ change over time during the heating process and cooling process, regardless of the amount of energy applied to the thermal head 6 during the heating process. More specifically, as the heating time progresses, both the first bonding strength F₁ and second bonding strength F₂ decrease, and as the cooling time progresses after heating, both the first bonding strength F₁ and second bonding strength F₂ increase.

The magnitude relationship between the first bonding strength F₁ and second bonding strength F₂ before heating and after cooling varies according to the amount of energy applied to the thermal head 6. For example, when the amount of energy applied to the thermal head 6 is relatively low, as illustrated in FIG. 8, the second bonding strength F₂ is greater than the first bonding strength F₁ both before heating and after cooling (the first state C₁). Therefore, when peeling is performed in the first state C₁, peeling occurs between the first thermal transfer layer 50 and second thermal transfer layer 52 since first bonding strength F₁<second bonding strength F₂, and the second thermal transfer layer 52 is transferred onto the printing tape 2. However, in order to establish the condition of first bonding strength F₁<second bonding strength F₂ after cooling, the cooling process is preferably executed longer than at least a time t₃ corresponding to the intersection 59 between the first bonding strength curve 57 and second bonding strength curve 58 illustrated in FIG. 8. This allows the thermal transfer recording medium 47 to be cooled sufficiently so that cold peeling can be reliably executed.

Further, for example, when the amount of energy applied to the thermal head 6 is relatively high, as illustrated in FIG. 9, the magnitude relationship between the first bonding strength F₁ and second bonding strength F₂ is reversed before heating and after cooling (the second state C₂). The second bonding strength F₂ is greater than the first bonding strength F₁ before heating but the second bonding strength F₂ is smaller than the first bonding strength F₁ after cooling (the second state C₂). In other words, the first bonding strength F₁ is irreversibly changed. Therefore, when peeling is performed in the second state C₂, peeling occurs between the base material layer 48 and first thermal transfer layer 50 since first bonding strength F₁>second bonding strength F₂, and the first thermal transfer layer 50 and second thermal transfer layer 52 are transferred onto the printing tape 2 in their bonded state. However, in order to establish the condition of first bonding strength F₁>second bonding strength F₂ after cooling, the cooling process is preferably executed longer than at least the time t₃ corresponding to the intersection 60 between the first bonding strength curve 57 and second bonding strength curve 58 illustrated in FIG. 9. This allows the thermal transfer recording medium 47 to be cooled sufficiently so that cold peeling can be reliably executed.

The time t₃ should be appropriately set so that first bonding strength F₁<second bonding strength F₂ after the thermal transfer recording medium 47 heated with low energy has been cooled and first bonding strength F₁>second bonding strength F₂ after the thermal transfer recording medium 47 heated with high energy has been cooled. For example, the time t₃ in both low energy application and high energy application may be the time required for the temperature of the thermal transfer recording medium 47 to drop to a temperature lower than the third temperature T₃. The peeling distance L₁ (see FIG. 1) needed for securing this time t₃ is greater than or equal to 70 mm and less than or equal to 150 mm, for example, and preferably greater than or equal to 90 mm and less than or equal to 120 mm.

By utilizing this irreversible change in the first bonding strength F₁, which occurs in accordance with the amount of energy applied to the thermal head 6, the peeling position of the thermal transfer recording medium 47 can be freely controlled, thereby providing a thermal transfer recording medium 47 capable of simultaneously recording characters in at least two colors with good clarity.

### [Peel Modes of the Thermal Transfer Recording Medium 47]

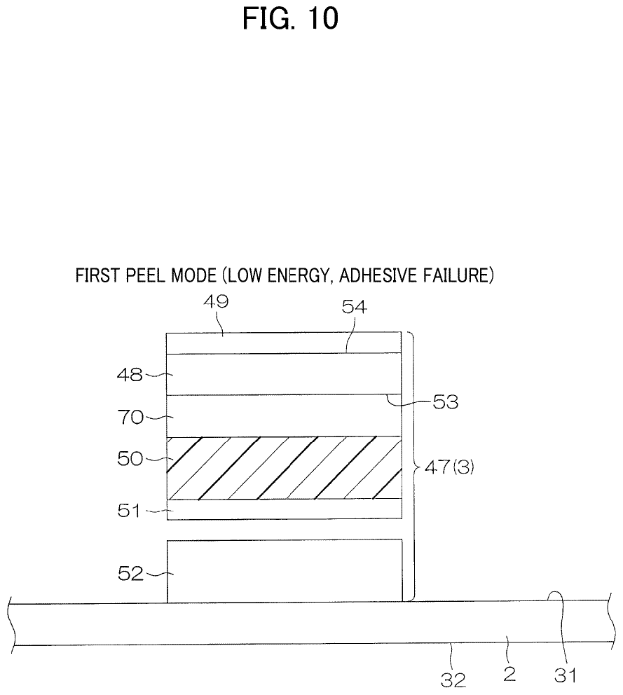

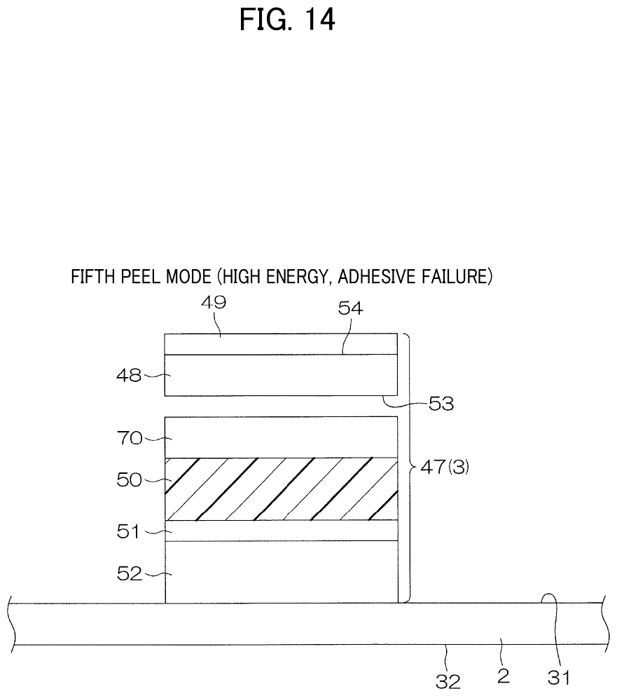

FIGS. 10 through 17 are diagrams illustrating peeling states of the thermal transfer recording medium 47. First, how the thermal transfer recording medium 47 peel off depending on the magnitude relationship between the first bonding strength F₁ and second bonding strength F₂ will be described with reference to FIGS. 10 through 17. Referring to FIGS. 10 through 17, the thermal transfer recording medium 47 has a plurality of peel modes. The peel modes in FIGS. 10 through 17 may be sequentially referred to as the first through eighth peel modes. These modes can be differentiated in terms of energy supplied to the thermal head 6 between the low energy peel modes illustrated in FIGS. 10 through 13, and the high energy peel modes illustrated in FIGS. 14 through 17.

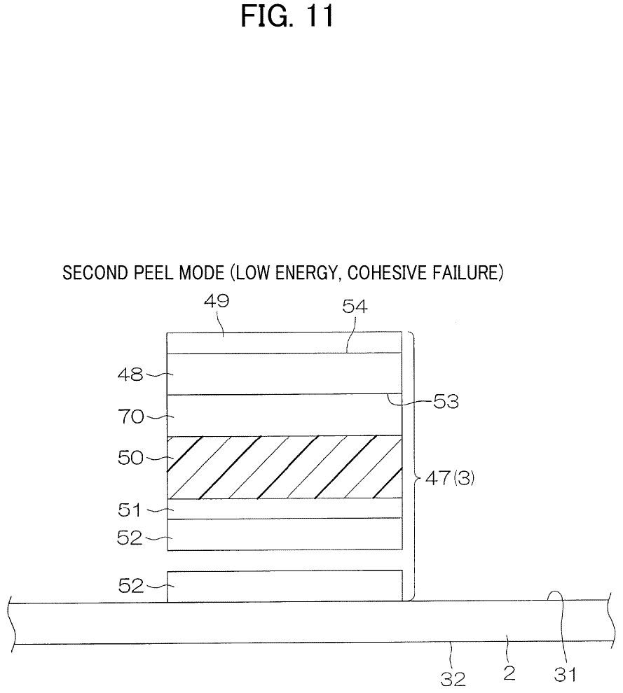

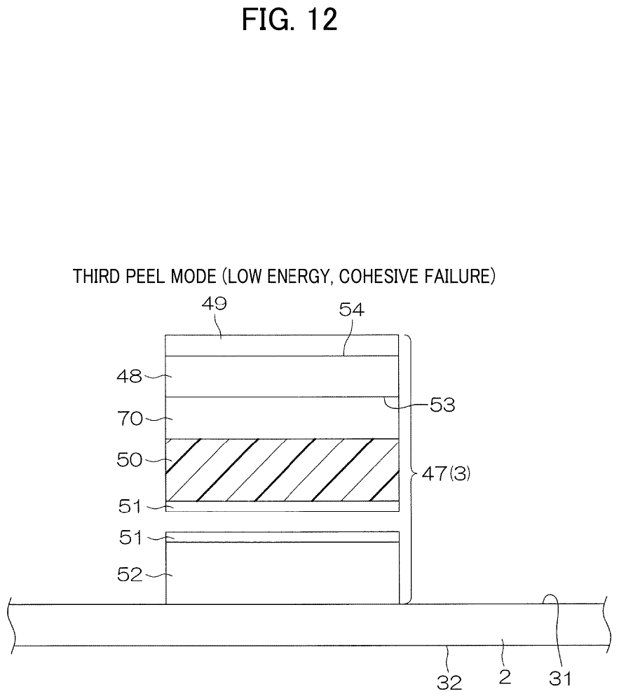

The peel modes in FIGS. 10 through 13 result when peeling (thermal transfer) is carried out in the first state C₁ via heating control (low energy application) of the first temperature curve 55 in FIG. 7. In the first peel mode of FIG. 10, the breaking strength (first bonding strength F₁) between the intermediate layer 51 and second thermal transfer layer 52 becomes weakest within the thermal transfer recording medium 47 in the first state C₁ and, hence, peeling occurs at this interface. In the second peel mode of FIG. 11, the breaking strength (first bonding strength F₁) within the second thermal transfer layer 52 becomes weakest in the thermal transfer recording medium 47 in the first state C₁ and, hence, peeling occurs within the second thermal transfer layer 52. In the third peel mode of FIG. 12, the breaking strength (first bonding strength F₁) within the intermediate layer 51 becomes weakest in the thermal transfer recording medium 47 in the first state C₁ and, hence, peeling occurs within the intermediate layer 51. In the fourth peel mode of FIG. 13, the layer contacting the second thermal transfer layer 52 in the first state C₁ is a mixed layer 61 in which components of the first thermal transfer layer 50 and intermediate layer 51 have been mixed through melting. The breaking strength (first bonding strength F₁) between the mixed layer 61 and second thermal transfer layer 52 becomes weakest in the thermal transfer recording medium 47 and, hence, peeling occurs at this interface. The first peel mode of FIG. 10 and the fourth peel mode of FIG. 13 constitute adhesive failures, while the second peel mode of FIG. 11 and the third peel mode of FIG. 12 constitute cohesive failures. The second thermal transfer layer 52 is transferred to the printing tape 2 in all of the peel modes of FIGS. 10 through 13.

The peel modes in FIGS. 14 through 17 result when peeling (thermal transfer) is carried out in the second state C₂ via heating control (high energy application) of the second temperature curve 56 in FIG. 7. As with the first through fourth peel modes, the peel modes in FIGS. 14 through 17 can also be differentiated between at least two of adhesive failure and cohesive failure.

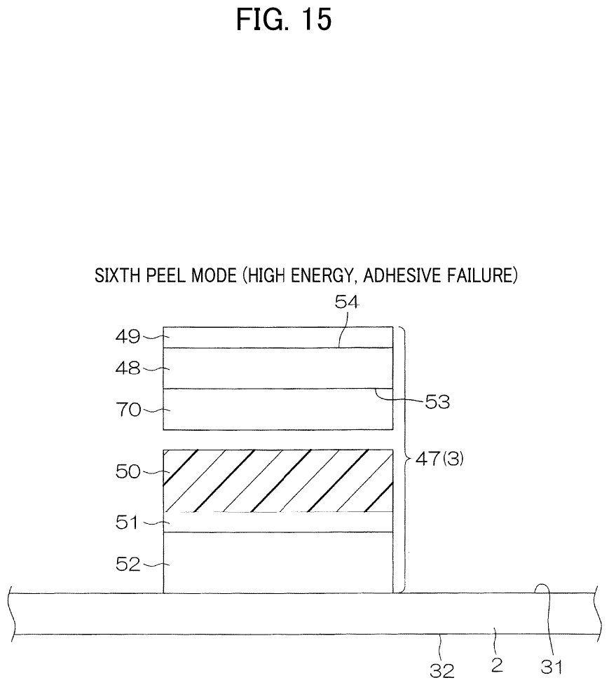

In the fifth peel mode of FIG. 14, the breaking strength (second bonding strength F₂) between the base material layer 48 and welding layer 70 becomes weakest in the thermal transfer recording medium 47 in the second state C₂ and, hence, peeling occurs at this interface (adhesive failure). In the sixth peel mode of FIG. 15, the breaking strength (second bonding strength F₂) between the welding layer 70 and first thermal transfer layer 50 becomes weakest in the thermal transfer recording medium 47 in the second state C₂ and, hence, peeling occurs at this interface (adhesive failure).

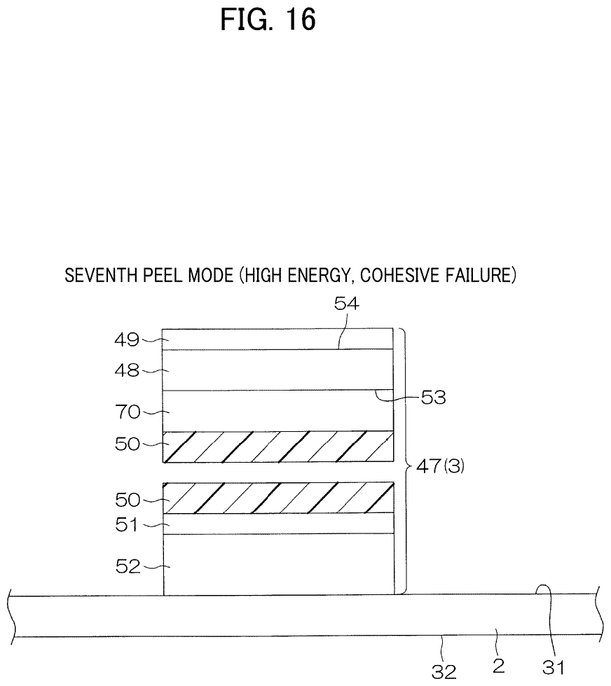

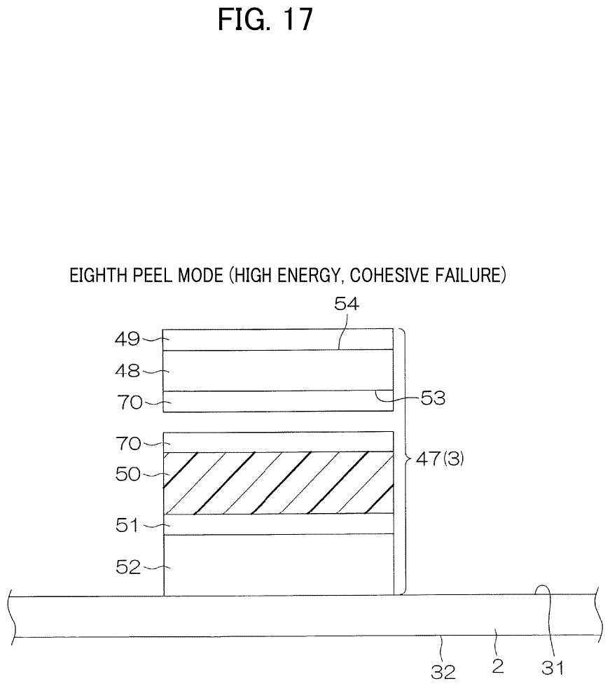

In the seventh peel mode of FIG. 16, the breaking strength (second bonding strength F₂) within the first thermal transfer layer 50 in the second state C₂ becomes weakest in the thermal transfer recording medium 47 in the second state C₂ and, hence, peeling occurs within the first thermal transfer layer 50 (cohesive failure). In the eighth peeling mode of FIG. 17, the breaking strength (the second bonding strength F₂) within the welding layer 70 becomes weakest in the thermal transfer recording medium 47 in the second state C₂ and, hence, peeling occurs within the welding layer 70 (cohesive failure).

In all of the peeling modes of FIGS. 14 through 17, the first thermal transfer layer 50 and second thermal transfer layer 52 are selectively transferred onto the printing tape 2 in their bonded state.

One can verify which peel mode from among those in FIGS. 10 through 17 resulted in breakage of the thermal transfer recording medium 47, for example, by observing a cross section of the thermal transfer recording medium 47 after breakage. For example, verification can be made on the basis of a scanning electron microscope (SEM) image, a transmission electron microscope (TEM) image, or the like of the thermal transfer recording medium 47 after breakage.

As described above, the characters recorded on the printing surface 31 of the printing tape 2 in the first through fourth peel modes have the hue of the second thermal transfer layer 52, e.g., red. The characters recorded on the printing surface 31 of the printing tape 2 in the fifth through eighth peel mode have the hue of the first thermal transfer layer 50, e.g., black.

Therefore, providing a thermal transfer recording medium 47 capable of simultaneously recording characters in at least two colors with good clarity requires achieving at least one of the first through fourth peel modes during heating control according to the first temperature curve 55 (low energy application) and achieving at least one of the fifth through eighth peel modes during heating control according to the second temperature curve 56 (high energy application). To achieve these targets, the conditions of each layer in the thermal transfer recording medium 47 were examined from the following perspectives.

### (2) Chemical Composition of Each Layer in the Thermal Transfer Recording Medium 47

From the perspective of chemical composition, the preferred chemical composition of each layer in the thermal transfer recording medium 47 corresponds to those of the base material layer 48, backing layer 49, welding layer 70, first thermal transfer layer 50, intermediate layer 51, and second thermal transfer layer 52 stipulated in the above section “[Introduction of a Welding Layer 70].” As such, the thermal transfer recording medium 47 having this chemical composition includes a welding layer 70 containing at least one type of resin selected from the group consisting of polyamide-based resins, polyester-based resins, epoxy-based resins, phenol-based resins, and polyvinyl alcohol-based resins. Therefore, irrespective of the temperature control depicted in FIG. 7, a general-purpose thermal transfer printer performing temperature control under common conditions can simultaneously record characters in at least two colors with good clarity.

When thermal transfers are executed on the printing device 1 using the temperature control illustrated in FIG. 7, other compositions can be employed for the intermediate layer 51 in addition to the thermoplastic elastomers described above. For example, the intermediate layer 51 may include at least one type of polyolefin-based resins and long-chain alkyl-based resins.

Examples of polyolefin-based resins include SURFLEN (registered trademark) P-1000 manufactured by MITSUBISHI CHEMICAL CORPORATION. “SURFLEN” is a Japanese registered trademark of MITSUBISHI CHEMICAL CORPORATION.

Examples of long-chain alkyl-based resins include 1010, 1010S, 1050, 1070, and 406 in the PEELOIL (registered trademark) series manufactured by LION SPECIALTY CHEMICALS CO., LTD. “PEELOIL” is a Japanese registered trademark of LION SPECIALTY CHEMICALS CO., LTD.

A thermal transfer recording medium 47 capable of simultaneously recording characters in at least two colors with good clarity can be provided using a welding layer 70 and an intermediate layer 51 that contain resins in the above examples.

### (3) Solubility Parameters (SP Values) of Layers in the Thermal Transfer Recording Medium 47

Here, the focus will be on relative relationships among the solubility parameters (SP values) and the softening points of components in layers of the thermal transfer recording medium 47 from the perspective of physical properties. The interlayer bonding strengths and interlayer peeling in the thermal transfer recording medium 47 can be controlled by adjusting the SP values and softening points of components in each layer. Components in contact with each other more easily adhere (have a higher affinity) the closer their SP values and more easily peel apart (have a lower affinity) the farther apart their SP values. Therefore, the peeling position in the thermal transfer recording medium 47 can be flexibly controlled by adjusting the balance of SP values and content ratios of the components in each layer of the thermal transfer recording medium 47. In this way, a thermal transfer recording medium 47 capable of simultaneously recording characters in at least two colors with good clarity is provided.

When specifying the relative relationships (magnitude relationships) among SP values in the following description, it is sufficient if the conditions for calculating the SP values being compared are the same. For example, the SP values may be HSP values (Hansen solubility parameters) or SP values (Hildebrand solubility parameters). Furthermore, there is no particular restriction on how the SP values are calculated. For example, calculation methods may include methods such as deriving the value from latent heat of vaporization, using the Hildebrand rule, estimating from physical properties such as surface tension; or using calculation methods based on molecular structure such as Small's method, Fedors' method, Hansen's method, or Hoy's method. Unless otherwise indicated, ranges and specific numerical values given for SP values in the present disclosure refer to SP values (Hildebrand solubility parameters).

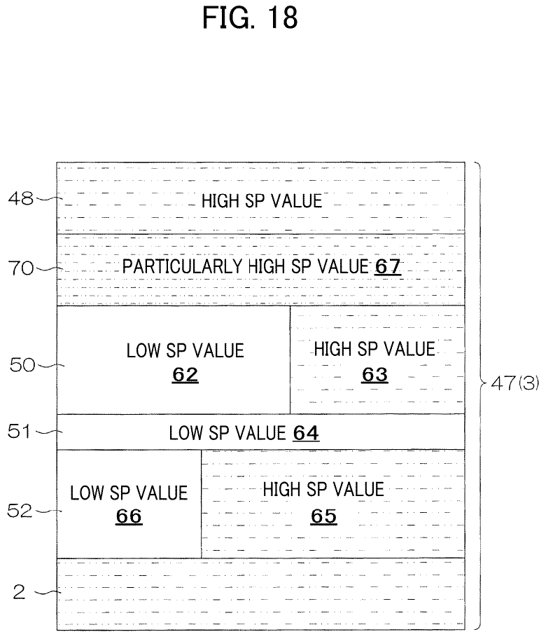

FIG. 18 is a diagram provided for comparing solubility parameters (SP values) of component materials in the thermal transfer recording medium 47 according to one embodiment of the present disclosure.

As shown in FIG. 18, the first thermal transfer layer 50 is configured of at least a first material 62 and a second material 63. The first material 62 is a material having a low SP value and softening point relative to the second material 63 The SP value of the first material 62 is between 7.5 and 9.5, for example, and preferably between 8.0 and 9.0. Examples of the first material 62 include the adhesive agents, tackifiers, and the like given as sample components of the first thermal transfer layer 50 in “[Introduction of a Welding Layer 70]” described above.

The second material 63 is a material having a high SP value and softening point relative to the first material 62. The SP value of the second material 63 is between 9.0 and 12.0, for example, and preferably between 10.0 and 11.0. The softening point of the second material 63 is greater than or equal to 60° C. and less than or equal to 150° C., for example, and preferably greater than or equal to 90° C. and less than or equal to 145° C. Examples of the second material 63 include the thermoplastic resins and the like given as sample components of the first thermal transfer layer 50 in “[Introduction of a Welding Layer 70]” described above.

As weight ratios of the first material 62 and second material 63 in the first thermal transfer layer 50, the first material 62 is greater than or equal to 30 parts by mass to 100 parts by mass of the second material 63, for example, and preferably greater than or equal to 45 parts by mass to 100 parts by mass of the second material 63. Further, the first material 62 is less than or equal to 300 parts by mass to 100 parts by mass of the second material 63, for example, and preferably less than or equal to 200 parts by mass to 100 parts by mass of the second material 63. Thus, the first material 62 is greater than or equal to 30 parts by mass and less than or equal to 300 parts by mass to 100 parts by mass of the second material 63, for example, and preferably greater than or equal to 45 parts by mass and less than or equal to 200 parts by mass to 100 parts by mass of the second material 63.

The intermediate layer 51 is configured of at least a third material 64. The third material 64 is a material having a low SP value relative to the second material 63 and a fourth material 65 (described later). The SP value of the third material 64 is between 7.5 and 10.0, for example, and preferably between 8.0 and 9.0. Examples of the third material 64 include the thermoplastic elastomers given in “[Introduction of a Welding Layer 70]” described above, as well as polyolefin-based resins, long-chain alkyl-based resins, and the like.

The second thermal transfer layer 52 is configured of at least a fourth material 65 and a fifth material 66.

The fourth material 65 is a material having a high SP value and softening point relative to the fifth material 66. The SP value of the fourth material 65 is between 9.0 and 12.0, for example, and preferably between 10.0 and 11.0. The softening point of the fourth material 65 is greater than or equal to 60° C. and less than or equal to 150° C., for example, and preferably greater than or equal to 90° C. and less than or equal to 145° C. Examples of the fourth material 65 include the thermoplastic resins and the like given as sample components of the second thermal transfer layer 52 in “[Introduction of a Welding Layer 70]” described above.

The fifth material 66 is a material having a low SP value and softening point relative to the fourth material 65. The SP value of the fifth material 66 is between 7.5 and 9.5, for example, and preferably between 8.0 and 9.0. The melting point of the fifth material 66 is greater than or equal to 60° C. and less than or equal to 120° C., for example, and preferably greater than or equal to 65° C. and less than or equal to 100° C. Examples of the fifth material 66 include waxes and the like given as sample components of the second thermal transfer layer 52 in “[Introduction of a Welding Layer 70]” described above.

As the weight ratios of the fourth material 65 and fifth material 66 in the second thermal transfer layer 52, the fifth material 66 is greater than or equal to 3 parts by mass to 100 parts by mass of the fourth material 65, for example, and preferably greater than or equal to 5 parts by mass to 100 parts by mass of the fourth material 65. Furthermore, the fifth material 66 is less than or equal to 11 parts by mass to 100 parts by mass of the fourth material 65, for example, and preferably less than or equal to 9 parts by mass to 100 parts by mass of the fourth material 65. Thus, the fifth material 66 is greater than or equal to 3 parts by mass and less than or equal to 11 parts by mass to 100 parts by mass of the fourth material 65, for example, and preferably greater than or equal to 5 parts by mass and less than or equal to 9 parts by mass.

The welding layer 70 is configured of at least a sixth material 67. The sixth material 67 is a material having a high SP value and softening point relative to the material in the base material layer 48 and the second material 63. The SP value of the sixth material 67 is between 9.0 and 14.0, for example, and preferably between 12.0 and 14.0. Examples of the sixth material 67 include at least one type of resin selected from the group consisting of polyamide-based resins, polyester-based resins, epoxy-based resins, phenol-based resins, and polyvinyl alcohol-based resins given in “[Introduction of a Welding Layer 70]” described above. Note that the phrase “extremely high SP value” shown in FIG. 18 refers to an SP value that is higher than the “high SP value” also depicted in FIG. 18.

Some examples of materials used for the base material layer 48 include films of the resins described above in “[Introduction of a Welding Layer 70],” thin paper such as condenser paper or glassine paper, cellophane, and the like.

The following is a summary of the relationships among SP values and softening points. First, with respect to SP values, the first material 62, third material 64, and fifth material 66 have smaller SP values than SP values of the second material 63, fourth material 65, and sixth material 67. Furthermore, the second material 63 and fourth material 65 have lower SP values than the sixth material 67. With respect to softening points, the first material 62, fourth material 65, and fifth material 66 have lower softening points than the second material 63 and third material 64. The softening points of the second material 63 and third material 64 are also lower than the softening point of the sixth material 67, and the softening points of the third material 64 and sixth material 67 are lower than the softening point of the base material layer 48.

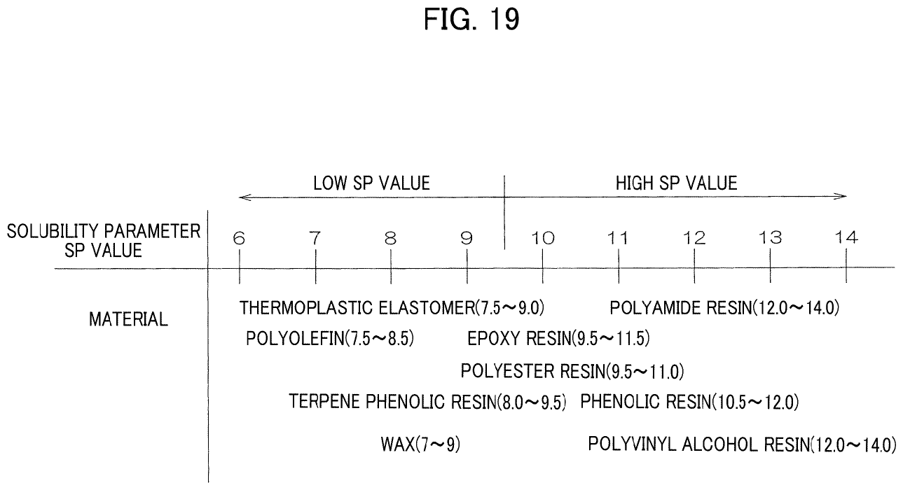

FIG. 19 is a diagram illustrating the magnitude relationships among types of materials forming parts of the thermal transfer recording medium 47 and the solubility parameters.

While the names of materials that can be used as the first through sixth materials 62-67 are given above as examples, the materials employed are not particularly limited, provided that they satisfy the relative relationships (magnitude relationships) described above among the SP values in the thermal transfer recording medium 47. For example, suitable materials can be selected by referring to the magnitude relationships shown in FIG. 19. The consideration at this time is that materials are more likely to bond the closer their SP values and more likely to peel apart the farther away their SP values.

For the first thermal transfer layer 50, for example, a terpene phenolic resin may be selected as the first material 62 and an epoxy resin may be selected as the second material 63. For the intermediate layer 51, for example, a thermoplastic elastomer, polyolefin, or the like may be selected as the third material 64. For the second thermal transfer layer 52, for example, an epoxy resin may be selected as the fourth material 65 and a wax may be selected as the fifth material 66. For the welding layer 70, for example, a polyamide-based resin with a particularly high SP value may be selected as the sixth material 67.

By employing SP values in the combination described above, at least one of the first through fourth peel modes can be attained during heating control that follows the first temperature curve 55 in FIG. 7 (low energy application), and at least one of the fifth through eighth peel modes can be attained during heating control that follows the second temperature curve 56 (high energy application).

Thermal transfer occurs in the thermal transfer recording medium 47 at a relatively low temperature when the amount of energy applied to the thermal head 6 (see FIGS. 1 and 3) is set to a low level, for example. In this case, the second thermal transfer layer 52 in this embodiment softens and its adhesion strength to the base material layer 48 decreases. At the same time, the adhesion strength between the first thermal transfer layer 50 and second thermal transfer layer 52 decreases. Since the welding layer 70 has a high softening point, the welding layer 70 softens very little at this time and maintains a strong adhesion strength between the base material layer 48 and first thermal transfer layer 50. This is because the SP value of the sixth material 67 in the welding layer 70 is relatively high, which tends to increase the cohesive strength and raise the softening point. As a result, a reverse transfer occurs during thermal transfer in which the first thermal transfer layer 50 and intermediate layer 51 remain on the base material layer 48 side while only the second thermal transfer layer 52 is thermally transferred onto the printing surface 31 of the printing tape 2. Therefore, the characters recorded on the printing surface 31 of the printing tape 2 will be the hue of the second thermal transfer layer 52, e.g., red. In other words, at least one of the first through fourth peel modes can be attained during low-temperature transfers.

On the other hand, thermal transfer occurs in the thermal transfer recording medium 47 at a higher temperature when the amount of energy applied to the thermal head 6 is set to a higher level. In this case, the welding layer 70 is further softened, greatly decreasing its adhesion strength to the base material layer 48, for example. As a result, the entire thermal transfer layer, i.e., the welding layer 70, first thermal transfer layer 50, intermediate layer 51, and second thermal transfer layer 52, are thermally transferred together onto the printing surface 31 of the printing tape 2. The characters recorded on the printing surface 31 of the printing tape 2 will be the hue of the first thermal transfer layer 50, which occupies the outermost layer after transfer, e.g., black. In other words, at least one of the fifth through eighth peel modes can be attained during high-temperature transfers. In this way, a thermal transfer recording medium 47 capable of simultaneously recording characters in at least two colors with good clarity can be provided.

### Working Examples

The present disclosure is further described below based on experimental examples, but the compositions used in the present disclosure are not limited to these examples.

### [Coating Material for First Thermal Transfer Layer (I)]

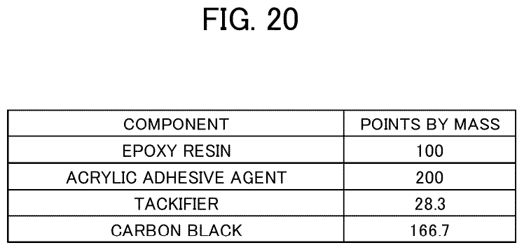

A coating material for the first thermal transfer layer (I) with a solid content concentration of 22.5% by mass was prepared by dissolving the components listed in a table illustrated in FIG. 20 in a solvent mixture of toluene and methyl ethyl ketone (MEK) at a mass ratio of 1/4. The ratio of active components in the acrylic adhesive agent was 80 parts by mass per 100 parts by mass of epoxy resin.

The components in the table in FIG. 20 are as follows:
Epoxy resin: jER (registered trademark) 1007 manufactured by MITSUBISHI CHEMICAL CORPORATION (basic solid type, softening point [ball and ring method]: 128° C., number average molecular weight Mn: about 2900, SP value: 9.5-11.5);
Acrylic adhesive agent: AS-665 manufactured by LION SPECIALTY CHEMICALS CO., LTD. (solid content concentration: 40% by mass, SP value: 8.0-9.5);
Tackifier: Terpene phenolic resin, YS POLYSTER T80 manufactured by YASUHARA CHEMICAL CO., LTD. (softening point: 80±5° C., SP value: 8.0-9.0); and
Carbon black: MA100 powder manufactured by MITSUBISHI CHEMICAL CORPORATION (LFF, DBP absorption number: 100 cm³/100 g).

### [Coating Material for Welding Layer (1)]

A coating material for a welding layer (1) with a solid content concentration of 10% by mass was prepared by dissolving a polyamide-based resin (TOHMIDE [registered trademark] 1315 manufactured by T&K TOKA Co., Ltd., SP value: 13.60, softening point: 130±5° C.) in a solvent mixture of toluene and methyl ethyl ketone (MEK) at a mass ratio of 1/1.

### [Coating Material for Welding Layer (2)]

A coating material for a welding layer (2) with a solid content concentration of 10% by mass was prepared by dissolving a polyvinyl alcohol resin (DENKA POVAL [registered trademark] B-05 manufactured by Denka Company, Limited, SP value: 12.60, softening point: 200° C.) in water.

### [Coating Material for Welding Layer (3)]

A coating material for a welding layer (3) with a solid content concentration of 10% by mass was prepared by dissolving a phenol-based resin (PHENOLITE [registered trademark] TD-2090 manufactured by DIC Corporation, SP value: 11.30, softening point: 117-123° C.) in a solvent mixture of toluene and methyl ethyl ketone (MEK) at a mass ratio of 1/1.

### [Coating Material for Welding Layer (4)]

A coating material for a welding layer (4) with a solid content concentration of 10% by mass was prepared by dissolving an epoxy resin (jER [registered trademark] 1001 manufactured by MITSUBISHI CHEMICAL CORPORATION, SP value: 10.90, softening point [ball and ring method]: 64° C.) in a solvent mixture of toluene and methyl ethyl ketone (MEK) at a mass ratio of 1/1.

### [Coating Material for Welding Layer (5)]

A coating material for a welding layer (5) with a solid content concentration of 10% by mass was prepared by dissolving a polyester-based resin (VYLON [registered trademark] GK-360 manufactured by TOYOBO Co., Ltd., SP value: 9.30, glass transition temperature: 56° C.) in a solvent mixture of toluene and methyl ethyl ketone (MEK) at a mass ratio of 1/1.

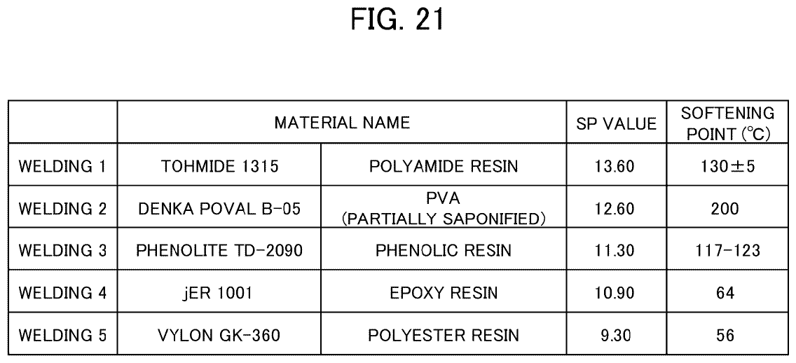

The material names, SP values, and softening points for the coating materials for the welding layers (1)-(5) are summarized in a table illustrated in FIG. 21. The composition ratios of their components have been omitted since solid/solvent=10/90 for all of the coating materials for the welding layers (1)-(5).

### [Coating Material for Intermediate Layer (1)]

A coating material for an intermediate layer (1) with a solid content concentration of 10% by mass was prepared by dissolving a thermoplastic elastomer (TUFTEC [registered trademark] H1521 manufactured by Asahi Kasei Corporation, SEBS, MFR: 2.3 g/10 min, styrene content 18% by mass, SP value: 7.5-9.0) in a solvent mixture of toluene and hexane at a mass ratio of 1/1.

### [Coating Material for Intermediate Layer (2)]

A coating material for an intermediate layer (2) was prepared similarly to the preparation of the coating material for the intermediate layer (1), except that the same amount of TUFTEC (registered trademark) H1517 manufactured by Asahi Kasei Corporation (SEBS, MFR: less than 3.0 g/10 min, styrene content: 43% by mass, SP value: 7.5-9.0) was substituted as the thermoplastic elastomer. The solid content concentration was 10% by mass.

### [Coating Material for Intermediate Layer (3)]

A coating material for an intermediate layer (3) was prepared similarly to the preparation of the coating material for the intermediate layer (1), except that the same amount of TUFTEC (registered trademark) H1272 manufactured by Asahi Kasei Corporation (SEBS, MFR: No Flow, styrene content: 35% by mass, SP value: 7.5-9.0) was substituted as the thermoplastic elastomer. The solid content concentration was 10% by mass.

### [Coating Material for Intermediate Layer (4)]

A coating material for an intermediate layer (4) was prepared similarly to the preparation of the coating material for the intermediate layer (1), except that the same amount of TUFTEC (registered trademark) H1221 manufactured by Asahi Kasei Corporation (SEBS, MFR: less than 4.5 g/10 min, styrene content: 12% by mass, SP value: 7.5-9.0) was substituted as the thermoplastic elastomer. The solid content concentration was 10% by mass.

### [Coating Material for Intermediate Layer (5)]

A coating material for an intermediate layer (5) was prepared similarly to the preparation of the coating material for the intermediate layer (1), except that the same amount of TUFTEC (registered trademark) H1043 manufactured by Asahi Kasei Corporation (SEBS, MFR: less than 2.0 g/10 min, styrene content: 67% by mass, SP value: 7.5-9.0) was substituted as the thermoplastic elastomer. The solid content concentration was 10% by mass.

### [Coating Material for Intermediate Layer (6)]

A coating material for an intermediate layer (6) was prepared similarly to the preparation of the coating material for the intermediate layer (1), except that the same amount of TUFPRENE (registered trademark) A manufactured by Asahi Kasei Corporation (SBS, MFR: 2.6 g/10 min, styrene content: 40% by mass, SP value: 7.5-9.0) was substituted as the thermoplastic elastomer. The solid content concentration was 10% by mass.

### [Coating Material for Intermediate Layer (7)]

A coating material for an intermediate layer (7) was prepared similarly to the preparation of the coating material for the intermediate layer (1), except that the same amount of Ultrathene (registered trademark) 634 manufactured by Tosoh Corporation (EVA, MFR: 4.3 g/10 min, SP value: 7.5-9.0) was substituted as the thermoplastic elastomer. The solid content concentration was 10% by mass.

### [Coating Material for Intermediate Layer (8)]

A coating material for an intermediate layer (8) was prepared similarly to the preparation of the coating material for the intermediate layer (1), except that the same amount of Ultrathene (registered trademark) 722 manufactured by Tosoh Corporation (EVA, MFR: 400 g/10 min, SP value: 7.5-9.0) was substituted as the thermoplastic elastomer. The solid content concentration was 10% by mass.

### [Coating Material for Intermediate Layer (9)]

A coating material for an intermediate layer (9) was prepared similarly to the preparation of the coating material for the intermediate layer (1), except that the same amount of Ultrathene (registered trademark) 725 manufactured by Tosoh Corporation (EVA, MFR: 1000 g/10 min, SP value: 7.5-9.0) was substituted as the thermoplastic elastomer. The solid content concentration was 10% by mass.

### [Coating Material for Intermediate Layer (10)]

A coating material for an intermediate layer (10) was prepared similarly to the preparation of the coating material for the intermediate layer (1), except that the same amount of Ultrathene (registered trademark) 684 manufactured by Tosoh Corporation (EVA, MFR: 2000 g/10 min, SP value: 7.5-9.0) was substituted as the thermoplastic elastomer. The solid content concentration was 10% by mass.

### [Coating Material for Intermediate Layer (11)]

A coating material for an intermediate layer (11) was prepared similarly to the preparation of the coating material for the intermediate layer (1), except that the same amount of a modified polyolefin resin (SURFLEN [registered trademark] P-1000 manufactured by MITSUBISHI CHEMICAL CORPORATION, SP value: 7.5-8.5) was substituted for the thermoplastic elastomer. The solid content concentration was 10% by mass.

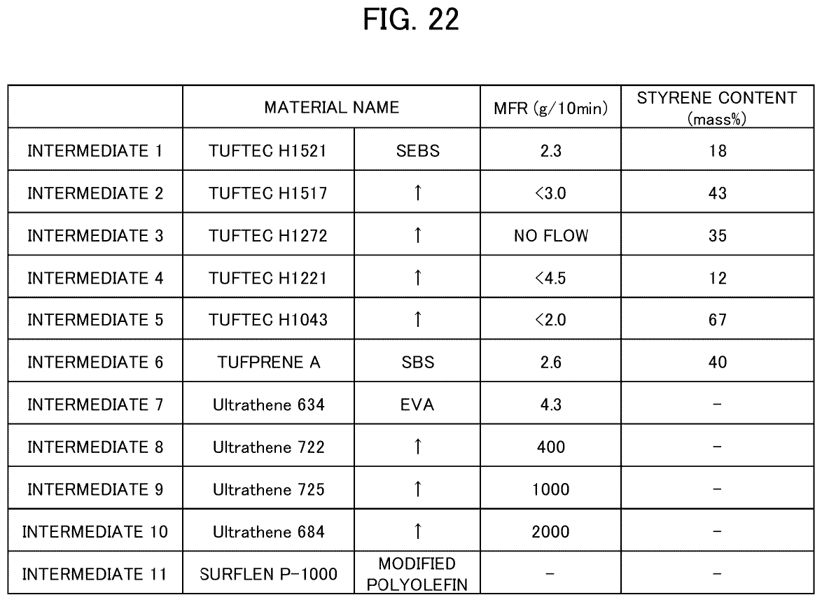

The material names, MFRs, and styrene contents of the coating materials for the intermediate layers (1)-(11) are summarized in a table illustrated in FIG. 22. The composition ratios of their components have been omitted since solid/toluene/hexane=10/45/45 for all of the coating materials for the intermediate layers (1)-(11).

### [Coating Material for Second Thermal Transfer Layer (I)]

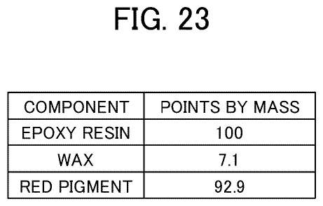

A coating material for the second thermal transfer layer (I) with a solid content concentration of 28% by mass was prepared by dissolving the components shown in a table illustrated in FIG. 23 in a solvent mixture of toluene and MEK at a mass ratio of 1/4.

The components in the table in FIG. 23 are as follows:
Epoxy resin: jER (registered trademark) 1004 manufactured by MITSUBISHI CHEMICAL CORPORATION (basic solid type, softening point [ball and ring method]: 97° C., number average molecular weight Mn: about 1650, SP value: 10.0-11.0);
Wax: carnauba wax No. 2 powder manufactured by TOYOCHEM CO., LTD. (melting point: 80-86° C., SP value: 7.0-9.0); and
Red pigment: C.I. pigment red 53:1 (SYMULER [registered trademark] Lake Red C-102 manufactured by DIC Corporation). “SYMULER” is a registered trademark of DIC CORPORATION.

### Experimental Examples 1-21

### (1) Manufacturing of a Thermal Transfer Recording Medium

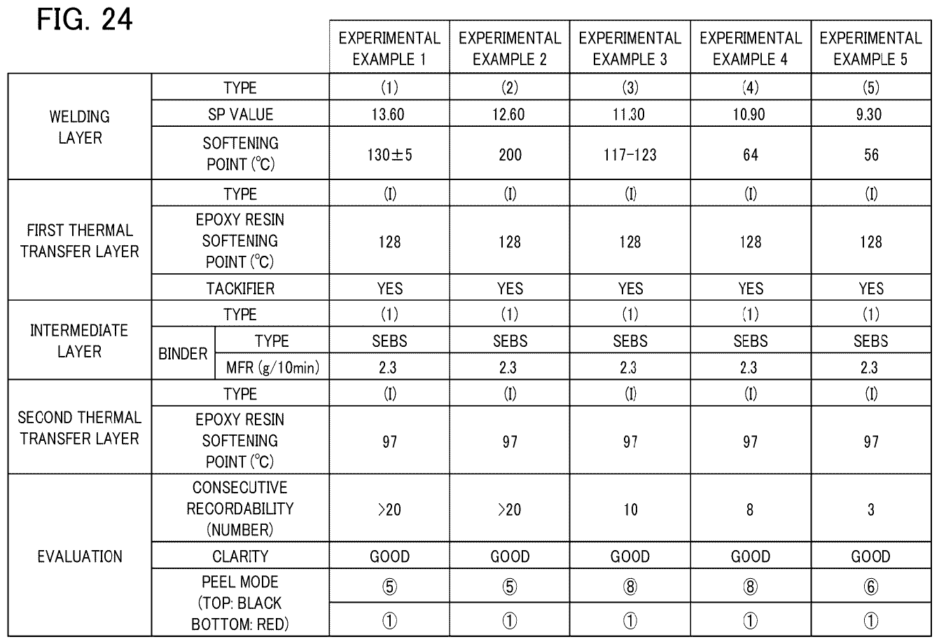

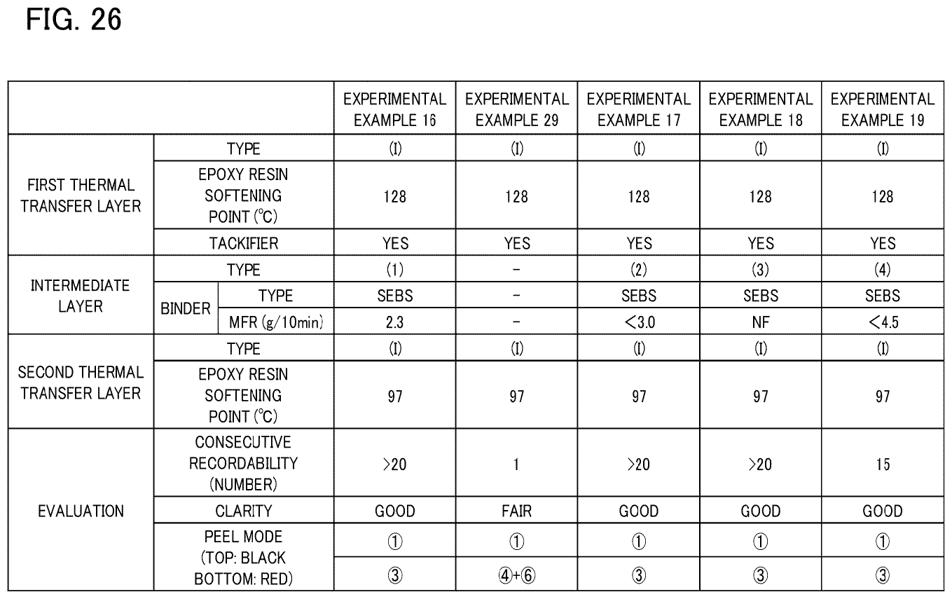

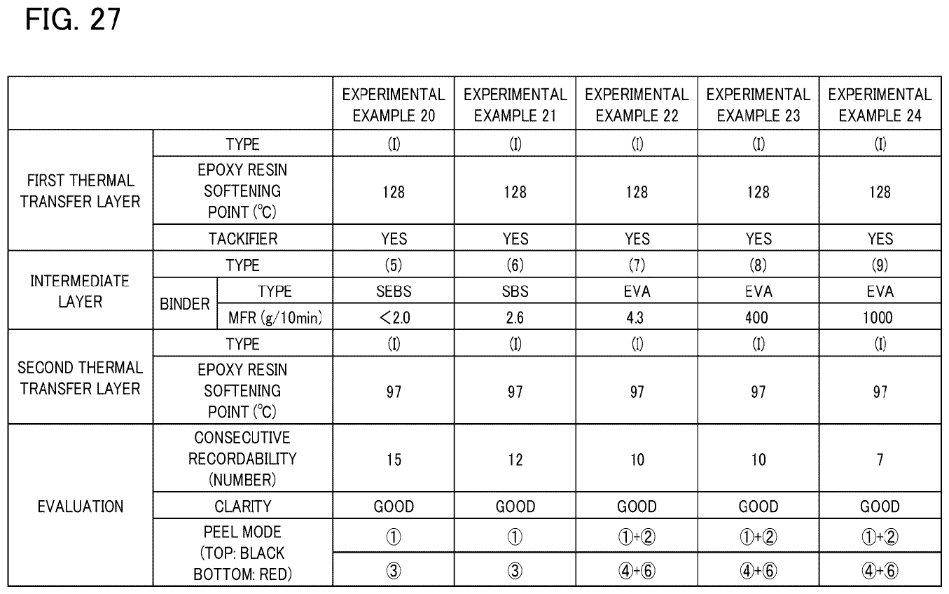

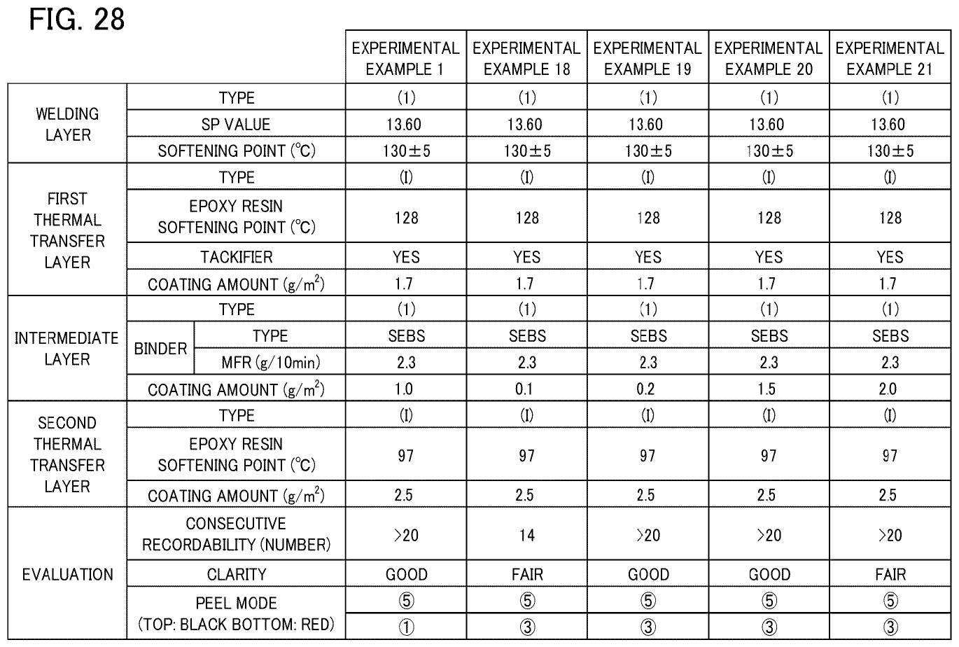

First, a PET film having a thickness of 4.5 μm was prepared as the base material layer. Next, a backing layer formed of a silicone resin and having a mass of solids per unit area of 0.1 g/m² was formed on the side surface (back surface) of the base material layer opposite the surface on which the thermal transfer layer was to be formed. Next, one of the previously prepared coating materials for the welding layer was applied to the front surface of the base material layer and then dried to form a welding layer with a mass of solids per unit area of 0.4 g/m². Next, the previously prepared coating material for the first thermal transfer layer was applied to the front surface of the welding layer and then dried to form a first thermal transfer layer with a mass of solids per unit area of 1.7 g/m². Next, one of the previously prepared coating materials for the intermediate layer was coated over the first thermal transfer layer and then dried to form an intermediate layer, if necessary. The coating amount of coating material for the intermediate layer was 1 g/m² of solids per unit area for experimental examples 1-16 and the amounts indicated in a table illustrated in FIG. 28 for experimental examples 18-21. Next, the previously prepared coating material for the second thermal transfer layer (I) was applied over the intermediate layer or first thermal transfer layer and then dried to form a second thermal transfer layer with a mass of solids per unit area of 2.5 g/m², thereby completing production of the thermal transfer recording medium. The composition of each layer in the thermal transfer recording media obtained in experimental examples 1-21 is shown in tables illustrated in FIGS. 24 through 28. The abbreviation “NF” in the row of the tables corresponding to the binder of the intermediate layer denotes “No Flow.”

### (2) Evaluations

### (2-1) Evaluation of Consecutive Recordability

The thermal transfer recording medium manufactured in each experimental example was slit into a ribbon shape with a prescribed width, rolled up, and set in a thermal transfer printer (a prototype printer manufactured by Brother Industries, Ltd.). This thermal transfer printer has the following main specifications:
Resolutions: 300-dpi line thermal head;
Resistance value of heating element: 1830Ω;
Transfer load: 30 N/2 inch;
Conveying speed: 20 mm/sec; and
Peeling distance: 110 mm.

Next, in an environment with an outside temperature of 25° C., the value of energy to be applied to the thermal head, which was preset in the thermal transfer printer, was set to either low energy (0.25 mJ/dot: 25 V [0.34 W/dot]/750 μsec, red) or high energy (0.34 mJ/dot: 25 V [0.34 W/dot]/100 μsec, black), and a solid image of 70 mm×70 mm was recorded 20 consecutive times on the surface of a label material for printing variable information (polyester film [white, glossy], FR1415-50 manufactured by LINTEC Corporation, SP value: 10.7, softening point: 240° C.). When some cloudiness was observed during recording, continuous printing was terminated at that point, and the number of times the image was printed consecutively in black or red was recorded as the number of consecutive prints. In this evaluation, experimental examples in which black was printed as many as 20 times were considered to have excellent consecutive printability for 20 or more prints, while experimental examples in which cloudiness occurred by the third print or earlier were considered to be insufficient for practical use. The results are shown in the tables in FIGS. 24 through 28.

### (2-2) Evaluation of Recording Clarity

The thermal transfer recording medium manufactured in each experimental example was slit into a ribbon shape with a prescribed width, rolled up, and set in a thermal transfer printer (a prototype printer manufactured by Brother Industries, Ltd.) having the same specifications as (2-1). Next, in an environment with an outside temperature of 25° C., the value of energy to be applied to the thermal head, which was preset in the thermal transfer printer, was set to either low energy (0.25 mJ/dot: 25 V [0.34 W/dot]/750 μsec, red) or high energy (0.34 mJ/dot: 25 V [0.34 W/dot]/1000 μsec, black), and a barcode was recorded on the surface of a label material for printing variable information (polyester film [white, glossy], FR1415-50 manufactured by LINTEC Corporation, SP value: 10.7, softening point: 240° C.). The recorded barcode was read with a barcode verifier (Laser Xaminer Elite IS manufactured by MUNAZO INC.) to find the decodability grade specified in the American National Standards Institute standard ANSI X3.182-1990, and recording clarity was evaluated under the following criteria:
GOOD: the decodability grade for both black and red was A (excellent) or B (superior);
FAIR: either black or red had a decodability grade of C (good) and the other had a grade of C (good) or better; and
POOR: at least one of black or red had a decodability grade of D (acceptable) or F (unacceptable).

The results are shown in the tables in FIGS. 24 through 28. Among experimental examples 1-17, experimental examples 1-16 and experimental examples 18-21 may be working examples, while experimental example 17 may be comparative example.

### (2-3) Observations of the Breaking Position

The thermal transfer recording medium manufactured in each experimental example was slit into a ribbon shape with a prescribed width, rolled up, and set in a thermal transfer printer (a prototype printer manufactured by Brother Industries, Ltd.) having the same specifications as (2-1). Next, in an environment with an outside temperature of 25° C., the value of energy to be applied to the thermal head, which was preset in the thermal transfer printer, was separately set to either low energy (0.25 mJ/dot: 25 V [0.34 W/dot]/750 μsec, attained temperature T_{R1}: 80° C., red) or high energy (0.34 mJ/dot: 25 V [0.34 W/dot]/1000 μsec, attained temperature T_{R2}: 140° C., black), and a solid image of 70 mm×70 mm was recorded on the surface of a label material for printing variable information (polyester film [white, glossy], FR1415-50 manufactured by LINTEC Corporation, SP value: 10.7, softening point: 240° C.). Since the thermal transfer printer allocated a peeling distance of 110 mm, the peeling process in both cases was performed after the image was sufficiently cooled (less than or equal to 60° C.). A cross section of the obtained solid image was observed using a transmission electron microscope (TEM: HT7820 manufactured by Hitachi High-Tech Corporation, accelerating voltage: 100 kV). It was verified for both black transfer and red transfer at which position in the thermal transfer recording medium the breakage occurred. The breaking positions were classified according to the following peel modes:
First peel mode: between the intermediate layer and the second thermal transfer layer (adhesive failure; see FIG. 10);
Second peel mode: within the second thermal transfer layer (cohesive failure; see FIG. 11);
Third peel mode: within the intermediate layer (cohesive failure; see FIG. 12);
Fourth peel mode: between the mixed layer and the second thermal transfer layer (adhesive failure; see FIG. 13);
Fifth peel mode: between the base material layer and the welding layer (adhesive failure; see FIG. 14);
Sixth peel mode: between the welding layer and the first thermal transfer layer (adhesive failure; see FIG. 15);
Seventh peel mode: within the first thermal transfer layer (cohesive failure; see FIG. 16); and
Eighth peel mode: within the welding layer (cohesive failure; see FIG. 17).

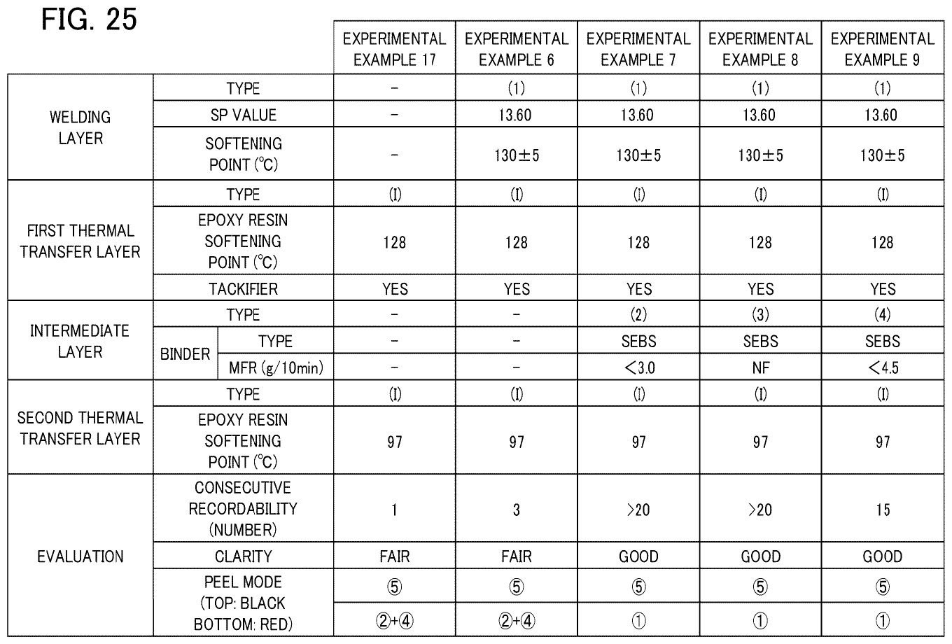

The results are shown in the tables in FIGS. 24 through 28. The first through eighth peel modes are denoted simply with numbers enclosed in circles in the tables in FIGS. 24 through 28. Further, multiple peel modes are given in the tables in FIGS. 24 through 28 to indicate that different peel modes resulted along the in-plane direction of the thermal transfer recording medium. Further, since the layered configurations of experimental examples 6 and 17 do not have an intermediate layer, the peeling modes in the bottom of the table in FIG. 25 are technically the cohesive failure that occurs when the intermediate layer 51 is omitted from FIGS. 11 and 13.

The comparisons between experimental examples 1-16 and experimental example 17 in the tables in FIGS. 24 through 27 show that a desired peeling mode can be attained by adjusting the balance of SP values for components in the welding layer, first thermal transfer layer, second thermal transfer layer, and intermediate layer with reference to FIG. 19, for example. As a result, it was found possible to obtain a thermal transfer recording medium that can clearly separate colors into two colors with little cloudiness of hues so that characters can be recorded with excellent clarity while avoiding the occurrence of excess peeling, even during continuous thermal transfer recording.

The comparisons between experimental examples 1-4 and experimental example 5 show that the SP value of the welding layer in particular should be higher than the SP value of the base layer (10.7) and the SP value of the epoxy resin in the first thermal transfer layer (10.0-11.0). This relationship can attain 10 or more consecutive recordings.

The comparison between experimental example 1 and experimental example 6 shows that an intermediate layer is preferably provided between the first thermal transfer layer and second thermal transfer layer. This configuration can provide a thermal transfer recording medium with both excellent consecutive recordability and clarity.

The comparisons between experimental examples 7-15 and experimental example 16 show that use of a thermoplastic elastomer as the intermediate layer is preferable with consideration for further improving consecutive recordability and clarity.

The results in experimental examples 1 and 7-15 show that EVA, SBS, SEBS, and the like are preferable thermoplastic elastomers for forming the intermediate layer. Furthermore, in consideration for further improving consecutive recordability, the MFR of the thermoplastic elastomer at a temperature of 190° C. and a load of 2.16 kg is preferably less than or equal to 1000 g/10 min, more preferably less than or equal to 400 g/10 min, even more preferably less than or equal to 2.5 g/10 min, and most preferably less than or equal to 2.3 g/10 min.

Experimental examples 1 and 18-21 show that consecutive recordability and clarity sufficient for practical use can be attained even when the coating amount of the intermediate layer is varied. Of these examples, experimental examples 1, 19, and 20 were found to have particularly excellent consecutive recordability and clarity. In examples 1, 19, and 20, the intermediate layer is the thinnest (the least amount of coating) among the layers configuring the thermal transfer recording medium, and the thickness (coating amount) of the intermediate layer is sufficiently large to fully exhibit the effects of introducing an intermediate layer.

In other words, the intermediate layer in experimental example 21 was not the thinnest among the layers configuring the thermal transfer recording medium but was relatively thick. As a result, the transferred area was larger (excessive peeling), leading to a decrease in clarity. Normally, when the thickness of one layer closer to the heat source is increased among adjacent layers, as in experimental example 21, the attained temperature at the interface between the two layers is reduced, which is thought to decrease the transfer area. However, a phenomenon can occur in which the bonding strength between the intermediate layer and the second thermal transfer layer (between “51” and “52” in FIG. 6) remains relatively low when the temperature at the interface decreases. As a result, the bonding strength between the intermediate layer and second thermal transfer layer becomes relatively lower than the bonding strength between the label material and the second thermal transfer layer (between “2” and “52” in FIG. 6) in peripheral portions of the barcode and breakage occurs between the intermediate layer and second thermal transfer layer, which likely increases excessive peeling.

On the other hand, the intermediate layer in experimental example 18 is the thinnest among the layers configuring the thermal transfer recording medium, but the coating amount of this layer is quite small (0.1 g/m²). Consequently, the intermediate layer did not fully fulfill its intended role, and a decline in both consecutive recordability and clarity was observed.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A thermal transfer recording medium comprising:
a base material layer having a first surface and a second surface;
a welding layer;
a first thermal transfer layer; and
a second thermal transfer layer, the welding layer, the first thermal transfer layer, and the second thermal transfer layer being in direct contact with each other and being laminated in this order on the first surface of the base material layer,
wherein the welding layer has a solubility parameter higher than a solubility parameter of each of the base material layer and the first thermal transfer layer.

2. A thermal transfer recording medium comprising:
a base material layer having a first surface and a second surface; and
a welding layer;
a first thermal transfer layer; and
a second thermal transfer layer, the welding layer, the first thermal transfer layer, and the second thermal transfer layer being in direct contact with each other and being laminated in this order on the first surface of the base material layer,
wherein when the thermal transfer recording medium is heated at a low temperature higher than or equal to a first temperature and lower than or equal to a second temperature, a bonding strength between the welding layer and the first thermal transfer layer is greater than a bonding strength between the first thermal transfer layer and the second thermal transfer layer, and
wherein when the thermal transfer recording medium is heated at a high temperature higher than the second temperature, the bonding strength between the first thermal transfer layer and the second thermal transfer layer is greater than a bonding strength between the base material layer and the first thermal transfer layer.

3. The thermal transfer recording medium according to claim 1,
wherein the welding layer contains at least one type of resin selected from a group consisting of a polyamide resin, a polyester resin, an epoxy resin, a phenolic resin, and a polyvinyl alcohol resin.

4. The thermal transfer recording medium according to claim 1,
wherein the first thermal transfer layer contains an epoxy resin and an acrylic adhesive agent.

5. The thermal transfer recording medium according to claim 1,
wherein the second thermal transfer layer contains a thermoplastic resin and a wax.

6. The thermal transfer recording medium according to claim 1,
wherein the welding layer has a softening point lower than a softening point of the base material layer and higher than or equal to a softening point of the first thermal transfer layer.

7. A thermal transfer recording medium comprising:
a base material layer;
a welding layer containing a welding material;
a first ink layer containing first ink; and
a second ink layer containing second ink, the base material layer, the welding layer, the first thermal transfer layer, and the second thermal transfer layer being laminated in this order, at least a portion of the first ink layer and the second ink layer being configured to be thermally transferred onto a printing medium,
wherein when external forces are applied to both the base material layer and the second ink layer in directions away from each other in a first state, a breakage occurs between the first ink layer and the second ink layer or within the second ink layer, the first state being a state in which the thermal transfer recording medium has been heated to a temperature higher than or equal to a first temperature and lower than or equal to a second temperature and subsequently cooled to a temperature lower than or equal to a third temperature,
wherein when the external forces are applied in a second state, a breakage occurs between the first ink layer and the base material layer or within the first ink layer, the second state being a state in which the thermal transfer recording medium has been heated to a temperature higher than the second temperature and subsequently cooled to a temperature lower than or equal to the third temperature.

8. The thermal transfer recording medium according to claim 7,
wherein when the external forces are applied in the first state, a breaking strength between the first ink layer and the second ink layer or within the second ink layer is weakest in the thermal transfer recording medium, and
wherein when the external forces are applied in the second state, a breaking strength between the first ink layer and the base material layer or within the first ink layer is weakest in the thermal transfer recording medium.

9. The thermal transfer recording medium according to claim 7,
wherein when the external forces are applied in the second state, a breakage occurs between the welding layer and the base material layer.

10. The thermal transfer recording medium according to claim 9,
wherein when the external forces are applied in the second state, a breaking strength between the welding layer and the base material layer is weakest in the thermal transfer recording medium.

11. The thermal transfer recording medium according to claim 7,
wherein the welding layer has a softening point lower than a softening point of the base material layer and higher than or equal to a softening point of the first ink layer.

12. The thermal transfer recording medium according to claim 7,
wherein the welding layer has a solubility parameter higher than a solubility parameter of each of the base material layer and the first ink layer.

13. The thermal transfer recording medium according to claim 7,
wherein the welding layer contains at least one type of resin selected from a group consisting of a polyamide resin, a polyester resin, an epoxy resin, a phenolic resin, and a polyvinyl alcohol resin.

14. The thermal transfer recording medium according to claim 7, further comprising:
an intermediate layer formed between the first ink layer and the second ink layer.

15. The thermal transfer recording medium according to claim 14,
wherein when the external forces are applied in the first state, a breakage occurs between the intermediate layer and the second ink layer.

16. The thermal transfer recording medium according to claim 15,
wherein when the external forces are applied in the first state, a breaking strength between the intermediate layer and the second ink layer is weakest in the thermal transfer recording medium.

17. The thermal transfer recording medium according to claim 15,
wherein the intermediate layer contains a thermoplastic styrenic elastomer.

18. The thermal transfer recording medium according to claim 17,
wherein the thermoplastic styrenic elastomer includes at least one type of a styrene-butadiene-styrene (SBS) block copolymer and a styrene-ethylene-butene-styrene (SEBS) block copolymer.

19. The thermal transfer recording medium according to claim 18,
wherein a styrene content in the thermoplastic styrenic elastomer is between 10% by mass and 70% by mass.

20. The thermal transfer recording medium according to claim 15,
wherein the intermediate layer contains a thermoplastic acetate ester-based elastomer.

21. The thermal transfer recording medium according to claim 20,
wherein the thermoplastic acetate ester-based elastomer includes an ethylene-vinyl acetate (EVA) copolymer.

22. The thermal transfer recording medium according to claim 14,
wherein the first ink layer and the intermediate layer are mixed in the first state.

23. The thermal transfer recording medium according to claim 14,
wherein when the external forces are applied in the first state, a breakage occurs within the intermediate layer.

24. The thermal transfer recording medium according to claim 23,
wherein when the external forces are applied in the first state, a breaking strength within the intermediate layer is weakest in the thermal transfer recording medium.

25. The thermal transfer recording medium according to claim 23,
wherein the intermediate layer contains at least one type of a polyolefin-based resin and a long-chain alkyl-based resin.

26. The thermal transfer recording medium according to claim 14,
wherein the first ink layer is configured of at least a first material and a second material,
wherein the intermediate layer is configured of a third material,
wherein the second ink layer is configured of a fourth material and a fifth material,
wherein the welding layer is configured of a sixth material,
wherein each of the first material, the third material, and the fifth material has a solubility parameter smaller than a solubility parameter of each of the second material, the fourth material, and the sixth material, and
wherein each of the second material and the fourth material has a solubility parameter smaller than a solubility parameter of the sixth material.

27. The thermal transfer recording medium according to claim 7,
wherein the first temperature is higher than the third temperature.

28. The thermal transfer recording medium according to claim 7,
wherein the first state is a state in which the base material layer of the thermal transfer recording medium has been heated to a temperature higher than or equal to the first temperature and lower than or equal to the second temperature and subsequently cooled to a temperature lower than or equal to the third temperature, and
wherein the second state is a state in which the base material layer of the thermal transfer recording medium has been heated to a temperature higher than the second temperature and subsequently cooled to a temperature lower than or equal to the third temperature.

29. A printing device configured perform:
a heating process heating a thermal transfer recording medium in a state where the thermal transfer recording medium is in contact with a printing medium, the thermal transfer recording medium including: a base material layer; a first ink layer containing first ink; and a second ink layer containing second ink, the base material layer, the first ink layer, and the second ink layer being laminated in this order;
a cooling process cooling the thermal transfer recording medium heated in the heating process; and
a transfer process transferring at least part of the first ink and the second ink onto the printing medium by applying external forces to both the base material layer and the second ink layer of the thermal transfer recording medium cooled in the cooling process in directions away from each other,
wherein in the heating process and the cooling process:
the printing device heats a first portion of the thermal transfer recording medium to a temperature higher than or equal to a first temperature and lower than or equal to a second temperature and subsequently cools the first portion to a temperature lower than or equal to a third temperature to place the first portion in a first state, and the printing device heats a second portion of the thermal transfer recording medium to a temperature higher than the second temperature and subsequently cools the second portion to a temperature lower than or equal to the third temperature to place the second portion in a second state,
wherein in the transfer process:
the printing device applies the external forces to break the thermal transfer recording medium between the first ink layer and the second ink layer or within the second ink layer at the first portion of the thermal transfer recording medium and transfer the second ink onto the printing medium; and
the printing device applies the external forces to break the thermal transfer recording medium between the first ink layer and the base material layer or within the first ink layer at the second portion of the thermal transfer recording medium and transfer the first ink and the second ink onto the printing medium.

30. A cassette accommodating therein:
a thermal transfer recording medium comprising:
a base material layer having a first surface and a second surface;
a welding layer;
a first thermal transfer layer; and
a second thermal transfer layer; and
a printing medium onto which a portion of the thermal transfer recording medium is to be thermally transferred,
wherein in the thermal transfer recording medium, the welding layer, the first thermal transfer layer, and the second thermal transfer layer are in direct contact with each other and are laminated in this order on the first surface of the base material layer, and
wherein the welding layer has a solubility parameter higher than a solubility parameter of each of the base material layer and the first thermal transfer layer.
